(19) United States
(12) Patent Application Publication
(10) Pub. No.: US 2022/0334358 A1
(43) Pub. Date: Oct. 20, 2022

(54) OPTICAL LENS SYSTEM, IMAGING DEVICE AND ELECTRONIC DEVICE

(71) Applicant: NEWMAX TECHNOLOGY CO., LTD., TAICHUNG CITY (TW)

(72) Inventor: Ya-Hsin Huang, TAICHUNG CITY (TW)

(21) Appl. No.: 17/374,998

(22) Filed: Jul. 14, 2021

(30) Foreign Application Priority Data
Apr. 14, 2021 (TW) 110113328

(51) Int. Cl. G02B 13/00; G02B 9/12; G02B 27/00

(52) U.S. Cl. CPC G02B 13/0035; G02B 9/12; G02B 27/0081; G02B 5/20

(57) ABSTRACT

An optical lens system includes, in order from the object side to the image side: a first lens with negative refractive power, a stop, a second lens with positive refractive power, and a third lens with positive refractive power, wherein a distance from an object-side surface of the first lens to an image-side surface of the third lens along an optical axis is TD, a distance from the image-side surface of the third lens to an image plane along the optical axis is BFL, half of a maximum view angle (field of view) of the optical lens system is HFOV, an incident pupil aperture of the optical lens system is EPD, and following conditions are satisfied: 1.82<TD/BFL<3.8 and 3.10<sin(HFOV)/EPD<8.12.

### BACKGROUND

### Field of the Invention

The present invention relates to an optical lens system, and more particularly to an optical lens system and imaging device applicable to electronic devices.

### Description of Related Art

The biometric identification (biometric) system based on the unique biometric characteristics of each organism, because of its uniqueness, universality, permanence, testability, convenience, acceptability, and impermissibility, it is often used in existing mobile devices on the current market, or even in future electronic devices. However, at present, the biometric identification system used in mobile devices is based on the principle of capacitance. Although it can reduce the dimension of the biometric identification system, the circuit design is too complex, which makes higher manufacturing cost and the product price will be higher accordingly.

Even though the optical imaging technical is applied to the traditional biometric identification systems, such as fingerprint identification, vein identification and so on, there is a problem with the dimension of the traditional biometric identification systems is too large to miniaturize the electronic devices equipped with the biometric identification systems and to be in portability.

The present invention mitigates and/or obviates the aforementioned disadvantages.

### SUMMARY

The primary objective of the present invention is to provide an optical lens system, imaging device and electronic device. When a specific condition is satisfied, the optical lens system of the present invention can satisfy the objective of miniaturization and improve the image quality.

Therefore, an optical lens system in accordance with the present invention comprises, in order from an object side to an image side: a first lens with negative refractive power, comprising an object-side surface and an image-side surface, the object-side surface of the first lens being concave near an optical axis, and at least one of the object-side surface and the image-side surface of the first lens being aspheric; a stop; a second lens with positive refractive power, comprising an object-side surface and an image-side surface, and at least one of the object-side surface and the image-side surface of the second lens being aspheric; and a third lens with positive refractive power, comprising an object-side surface and an image-side surface, and at least one of the object-side surface and the image-side surface of the third lens being aspheric.

Wherein a distance from the object-side surface of the first lens to the image-side surface of the third lens along the optical axis is TD, a distance from the image-side surface of the third lens to an image plane along the optical axis is BFL, half of a maximum view angle (field of view) of the optical lens system is HFOV, an incident pupil aperture of the optical lens system is EPD, and following conditions are satisfied: 1.82<TD/BFL<3.8 and 3.10<sin(HFOV)/EPD<8.12.

Preferably, the optical lens system has a total of three lenses with refractive power.

The present invention has the following effect: if the above three lenses with refractive power satisfy the condition 1.82<TD/BFL<3.8, it can meet the requirement of miniaturization. Preferably, following condition can be satisfied: 2.05<TD/BFL<3.7. If the above three lenses with refractive power satisfy the condition 3.10<sin(HFOV)/EPD<8.12, it is favorable to shorten the distance between an object and the image plane and can effectively collect large angle light, achieving the effects of thinning and identification. Preferably, following condition can be satisfied: 3.48<sin(HFOV)/EPD<7.44.

Preferably, the distance from the object-side surface of the first lens to the image-side surface of the third lens along the optical axis is TD, the incident pupil aperture of the optical lens system is EPD, and following condition is satisfied: 4.06<TD/EPD<12.97, which can achieve a balance between the big stop and thinning of the optical lens system. Preferably, following condition can be satisfied: 4.57<TD/EPD<11.89.

Preferably, the distance from the image-side surface of the third lens to the image plane along the optical axis is BFL, and following condition is satisfied: 0.36 mm<BFL<0.58 mm, so as to meet the requirement of miniaturization. Preferably, following condition can be satisfied: 0.37 mm<BFL<0.56 mm.

Preferably, the incident pupil aperture of the optical lens system is EPD, and following condition is satisfied: 0.11<EPD<0.29, which can effectively improve the illumination and optical properties of the system. Preferably, following condition can be satisfied: 0.13<EPD<0.27.

Preferably, half of the maximum view angle (field of view) of the optical lens system is HFOV, the distance from the image-side surface of the third lens to the image plane along the optical axis is BFL, a focal length of the optical lens system is f, and following condition is satisfied: 4.36<sin(HFOV)/(BFL*f)<11.64, which can ensure that the lens system has sufficient view angle to obtain the desired image range. Preferably, following condition can be satisfied: 4.61<sin(HFOV)/(BFL*f)<11.11.

Preferably, half of the maximum view angle (field of view) of the optical lens system is HFOV, the distance from the object-side surface of the first lens to the image-side surface of the third lens along the optical axis is TD, the incident pupil aperture of the optical lens system is EPD, and following condition is satisfied: 4.83<TD/(EPD*sin(HFOV))<12.45, which can ensure that the lens system has sufficient view angle to obtain the desired image range. Preferably, following condition can be satisfied: 5.09<TD/(EPD*sin(HFOV))<11.88.

An imaging device in accordance with the present invention comprises, in order from an object side to an image side: a flat panel, an optical lens system, and an image sensor. Wherein the optical lens system comprises, in order from the object side to the image side: a first lens with negative refractive power, comprising an object-side surface and an image-side surface, the object-side surface of the first lens being concave near an optical axis, and at least one of the object-side surface and the image-side surface of the first lens being aspheric; a stop; a second lens with positive refractive power, comprising an object-side surface and an image-side surface, and at least one of the object-side surface and the image-side surface of the second lens being aspheric; and a third lens with positive refractive power, comprising an object-side surface and an image-side surface, and at least one of the object-side surface and the image-side surface of the third lens being aspheric.

Wherein half of a maximum view angle (field of view) of the optical lens system is HFOV, a distance from an object-side surface of the flat panel to the object-side surface of the first lens along the optical axis is OPL, a distance from the object-side surface of the first lens to the image-side surface of the third lens along the optical axis is TD, a distance from the object-side surface of the flat panel to an image plane along the optical axis is OTL, and following conditions are satisfied: 0.34<sin(HFOV)/OPL<0.71 and 0.25<TD/OTL<0.44.

Preferably, the optical lens system has a total of three lenses with refractive power.

The present invention has the following effect: if the above three lenses with refractive power satisfy the condition 0.34<sin(HFOV)/OPL<0.71, it is favorable to shorten the distance between an object and the image plane and can effectively collect large angle light, achieving the effects of thinning and identification. Preferably, following condition can be satisfied: 0.39<sin(HFOV)/OPL<0.65. If the above three lenses with refractive power satisfy the condition 0.25<TD/OTL<0.44, it can meet the requirement of miniaturization. Preferably, following condition can be satisfied: 0.28<TD/OTL<0.42.

Preferably, the distance from the object-side surface of the flat panel to the image plane along the optical axis is OTL, an incident pupil aperture of the optical lens system is EPD, and following condition is satisfied: 12.11<OTL/EPD<30, which can achieve a balance between the big stop and thinning of the imaging device. Preferably, following condition can be satisfied: 13.63<OTL/EPD<28.84.

Preferably, the distance from the object-side surface of the first lens to the image-side surface of the third lens along the optical axis is TD, the distance from the object-side surface of the flat panel to the object-side surface of the first lens along the optical axis is OPL, and following condition is satisfied: 0.42<TD/OPL<1.04, so as to meet the requirement of miniaturization. Preferably, following condition can be satisfied: 0.48<TD/OPL<0.95.

Preferably, a distance from the image-side surface of the third lens to the image plane along the optical axis is BFL, and following condition is satisfied: 0.36 mm<BFL<0.58 mm, so as to meet the requirement of miniaturization. Preferably, following condition can be satisfied: 0.37 mm<BFL<0.56 mm.

Preferably, the distance from the object-side surface of the first lens to the image-side surface of the third lens along the optical axis is TD, the distance from the image-side surface of the third lens to the image plane along the optical axis is BFL, and following condition is satisfied: 1.82<TD/BFL<3.8, so as to meet the requirement of miniaturization. Preferably, following condition can be satisfied: 2.05<TD/BFL<3.7.

Preferably, the distance from the object-side surface of the first lens to the image-side surface of the third lens along the optical axis is TD, the incident pupil aperture of the optical lens system is EPD, and following condition is satisfied: 4.06<TD/EPD<12.97, which can achieve a balance between the big stop and thinning of the imaging device. Preferably, following condition can be satisfied: 4.57<TD/EPD<11.89.

Preferably, the distance from the object-side surface of the flat panel to the image plane along the optical axis is OTL, and following condition is satisfied: 2.84 mm<OTL<4.35 mm, so as to meet the requirement of miniaturization. Preferably, following condition can be satisfied: 2.99 mm<OTL<4.16 mm.

Preferably, the distance from the object-side surface of the flat panel to the object-side surface of the first lens along the optical axis is OPL, and following condition is satisfied: 1.35 mm<OPL<2.66 mm, so as to meet the requirement of miniaturization. Preferably, following condition can be satisfied: 1.52 mm<OPL<2.43 mm.

Preferably, half of the maximum view angle (field of view) of the optical lens system is HFOV, the incident pupil aperture of the optical lens system is EPD, and following condition is satisfied: 3.1<sin(HFOV)/EPD<8.12, which is favorable to shorten the distance between the object and the image plane and can effectively collect large angle light, achieving the effects of thinning and identification. Preferably, following condition can be satisfied: 3.48<sin(HFOV)/EPD<7.44.

Preferably, the incident pupil aperture of the optical lens system is EPD, and following condition is satisfied: 0.11<EPD<0.29, which can effectively improve the illumination and optical properties of the system. Preferably, following condition can be satisfied: 0.13<EPD<0.27.

Preferably, half of the maximum view angle (field of view) of the optical lens system is HFOV, the distance from the image-side surface of the third lens to the image plane along the optical axis is BFL, a focal length of the optical lens system is f, and following condition is satisfied: 4.36<sin(HFOV)/(BFL*f)<11.64, which can ensure that the lens system has sufficient view angle to obtain the desired image range. Preferably, following condition can be satisfied: 4.61<sin(HFOV)/(BFL*f)<11.11.

Preferably, half of the maximum view angle (field of view) of the optical lens system is HFOV, the distance from the object-side surface of the first lens to the image-side surface of the third lens along the optical axis is TD, the incident pupil aperture of the optical lens system is EPD, and following condition is satisfied: 4.83<TD/(EPD*sin(HFOV))<12.45, which can ensure that the lens system has sufficient view angle to obtain the desired image range. Preferably, following condition can be satisfied: 5.09<TD/(EPD*sin(HFOV))<11.88.

For each of the above optical lens systems or the imaging device, wherein the focal length of the optical lens system is f, and following condition is satisfied: 0.19 mm<f<0.41 mm Preferably, following condition can be satisfied: 0.21 mm<f<0.39 mm.

For each of the above optical lens systems or the imaging device, a f-number of the optical lens system is Fno, and following condition is satisfied: 1.33<Fno<1.74. Preferably, following condition can be satisfied: 1.41<Fno<1.66.

For each of the above optical lens systems or the imaging device, the optical lens system has a maximum view angle (field of view) FOV, and following condition is satisfied 124.74 degrees<FOV<180.95 degrees. Preferably, following condition can be satisfied: 131.67 degrees<FOV<172.73 degrees.

An electronic device in accordance with the present invention comprises the above imaging device, a control unit electrically connected to the imaging device, and a storage unit electrically connected to the control unit.

The present invention will be presented in further details from the following descriptions with the accompanying drawings, which show, for purpose of illustrations only, the preferred embodiments in accordance with the present invention.

### BRIEF DESCRIPTION OF THE DRAWINGS

FIG. 1A shows an optical lens system in accordance with a first embodiment of the present invention;

FIG. 1B shows the image plane curve and the distortion curve of the first embodiment of the present invention;

FIG. 1C shows an imaging device in accordance with the first embodiment of the present invention;

FIG. 2A shows an optical lens system in accordance with a second embodiment of the present invention;

FIG. 2B shows the image plane curve and the distortion curve of the second embodiment of the present invention;

FIG. 2C shows an imaging device in accordance with the second embodiment of the present invention;

FIG. 3A shows an optical lens system in accordance with a third embodiment of the present invention;

FIG. 3B shows the image plane curve and the distortion curve of the third embodiment of the present invention;

FIG. 3C shows an imaging device in accordance with the third embodiment of the present invention;

FIG. 4A shows an optical lens system in accordance with a fourth embodiment of the present invention;

FIG. 4B shows the image plane curve and the distortion curve of the fourth embodiment of the present invention;

FIG. 4C shows an imaging device in accordance with the fourth embodiment of the present invention;

FIG. 5A shows an optical lens system in accordance with a fifth embodiment of the present invention;

FIG. 5B shows the image plane curve and the distortion curve of the fifth embodiment of the present invention;

FIG. 5C shows an imaging device in accordance with the fifth embodiment of the present invention;

FIG. 6A shows an optical lens system in accordance with a sixth embodiment of the present invention;

FIG. 6B shows the image plane curve and the distortion curve of the sixth embodiment of the present invention;

FIG. 6C shows an imaging device in accordance with the sixth embodiment of the present invention;

FIG. 7A shows an optical lens system in accordance with a seventh embodiment of the present invention;

FIG. 7B shows the image plane curve and the distortion curve of the seventh embodiment of the present invention;

FIG. 7C shows an imaging device in accordance with the seventh embodiment of the present invention;

FIG. 8A shows an optical lens system in accordance with an eighth embodiment of the present invention;

FIG. 8B shows the image plane curve and the distortion curve of the eighth embodiment of the present invention;

FIG. 8C shows an imaging device in accordance with the eighth embodiment of the present invention;

FIG. 9A shows an optical lens system in accordance with a ninth embodiment of the present invention;

FIG. 9B shows the image plane curve and the distortion curve of the ninth embodiment of the present invention;

FIG. 9C shows an imaging device in accordance with the ninth embodiment of the present invention;

FIG. 10A shows an optical lens system in accordance with a tenth embodiment of the present invention;

FIG. 10B shows the image plane curve and the distortion curve of the tenth embodiment of the present invention;

FIG. 10C shows an imaging device in accordance with the tenth embodiment of the present invention;

FIG. 11A shows an optical lens system in accordance with an eleventh embodiment of the present invention;

FIG. 11B shows the image plane curve and the distortion curve of the eleventh embodiment of the present invention;

FIG. 11C shows an imaging device in accordance with the eleventh embodiment of the present invention;

FIG. 12A shows an optical lens system in accordance with a twelfth embodiment of the present invention;

FIG. 12B shows the image plane curve and the distortion curve of the twelfth embodiment of the present invention;

FIG. 12C shows an imaging device in accordance with the twelfth embodiment of the present invention;

FIG. 13 shows the imaging device that includes the optical lens system is disposed on an electronic device in accordance with the first embodiment of the present invention; and

FIG. 14 is a cross sectional side view of FIG. 13.

### DETAILED DESCRIPTION

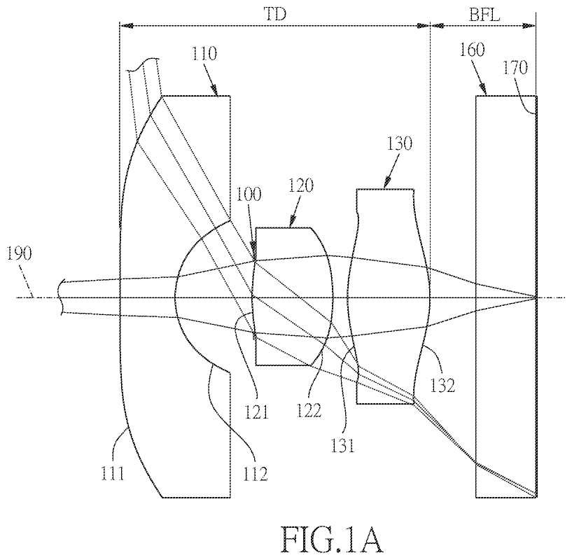

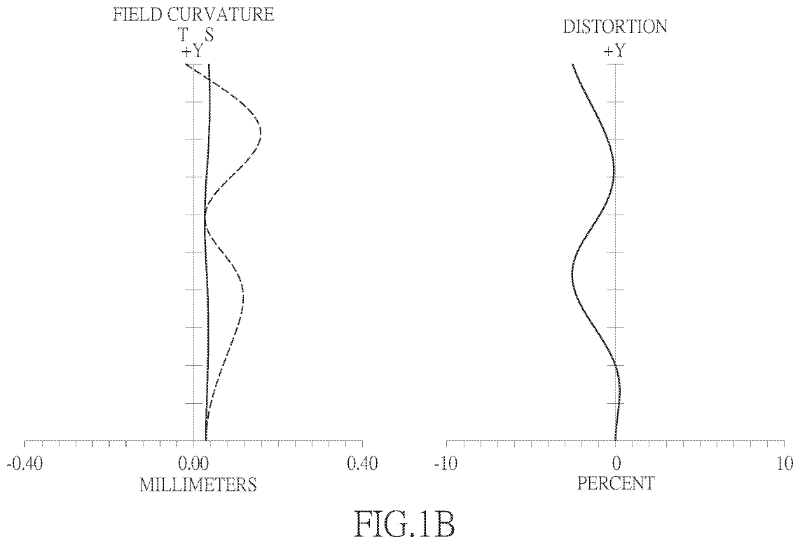

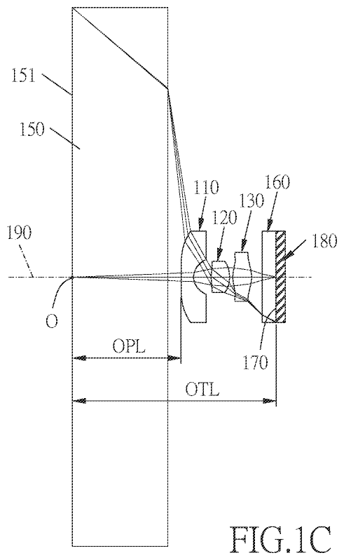

Referring to FIGS. 1A, 1B and 1C, FIG. 1A shows an optical lens system in accordance with a first embodiment of the present invention, FIG. 1B shows, in order from left to right, the image plane curve and the distortion curve of the first embodiment of the present invention, and FIG. 1C shows an imaging device in accordance with the first embodiment of the present invention. An optical lens system in accordance with the first embodiment of the present invention comprises, in order from an object side to an image side: a first lens 110, a stop 100, a second lens 120, a third lens 130, an IR-cut filter 160, and an image plane 170. The optical lens system has a total of three lenses with refractive power, but not limited to this. An imaging device in accordance with the first embodiment of the present invention comprises, in order from the object side to the image side: a flat panel 150, the above optical lens system (not shown), and an image sensor 180. The image sensor 180 is disposed on the image plane 170.

The flat panel 150 made of glass is located between an object O and the first lens 110 and has no influence on the focal length of the optical lens system. The flat panel 150 can be made of other materials.

The first lens 110 with negative refractive power, comprising an object-side surface 111 and an image-side surface 112, the object-side surface 111 of the first lens 110 being concave near an optical axis 190 and the image-side surface 112 of the first lens 110 being concave near the optical axis 190, the object-side surface 111 and the image-side surface 112 of the first lens 110 are aspheric, and the first lens 110 is made of plastic material.

The second lens 120 with positive refractive power, comprising an object-side surface 121 and an image-side surface 122, the object-side surface 121 of the second lens 120 being convex near the optical axis 190 and the image-side surface 122 of the second lens 120 being convex near the optical axis 190, the object-side surface 121 and the image-side surface 122 of the second lens 120 are aspheric, and the second lens 120 is made of plastic material.

The third lens 130 with positive refractive power, comprising an object-side surface 131 and an image-side surface 132, the object-side surface 131 of the third lens 130 being convex near the optical axis 190 and the image-side surface 132 of the third lens 130 being convex near the optical axis 190, the object-side surface 131 and the image-side surface 132 of the third lens 130 are aspheric, and the third lens 130 is made of plastic material.

The IR-cur filter 160 made of glass is located between the third lens 130 and the image plane 170 and has no influence on the focal length of the optical lens system. The IR-cut filter 160 can also be formed on the surfaces of the lenses and made of other materials.

The equation for the aspheric surface profiles of the respective lenses of the first embodiment is expressed as follows:

$$z = \frac{{ch}^{2}}{1 + {[ 1 - ( k + 1 ) {c}^{2} {h}^{2} ]}^{0.5}} + {Ah}^{4} + {Bh}^{6} + {Ch}^{8} + {Dh}^{10} + {Eh}^{12} + {Fh}^{14} + {Gh}^{16} …$$

wherein:

z represents the value of a reference position with respect to a vertex of the surface of a lens and a position with a height h along the optical axis 190;

c represents a paraxial curvature equal to 1/R (R: a paraxial radius of curvature);

h represents a vertical distance from the point on the curve of the aspheric surface to the optical axis 190;

k represents the conic constant;

A, B, C, D, E, F, G, . . . : represent the high-order aspheric coefficients.

In the first embodiment of the present optical lens system, a focal length of the optical lens system is f, a f-number of the optical lens system is Fno, the optical lens system has a maximum view angle FOV, and following conditions are satisfied: f=0.25 mm; Fno=1.52; and FOV=164.5 degrees.

In the first embodiment of the present optical lens system, a distance from the object-side surface 111 of the first lens 110 to the image-side surface 132 of the third lens 130 along the optical axis 190 is TD, a distance from the image-side surface 132 of the third lens 130 to the image plane 170 along the optical axis 190 is BFL, and following condition is satisfied: TD/BFL=2.90.

In the first embodiment of the present optical lens system, half of the maximum view angle (field of view) of the optical lens system is HFOV, an incident pupil aperture of the optical lens system is EPD, and following condition is satisfied: sin(HFOV)/EPD=6.01.

In the first embodiment of the present optical lens system, the distance from the object-side surface 111 of the first lens 110 to the image-side surface 132 of the third lens 130 along the optical axis 190 is TD, the incident pupil aperture of the optical lens system is EPD, and following condition is satisfied: TD/EPD=6.61. In the first embodiment of the present optical lens system, the distance from the image-side surface 132 of the third lens 130 to the image plane 170 along the optical axis 190 is BFL, and following condition is satisfied: BFL=0.38 mm.

In the first embodiment of the present optical lens system, the incident pupil aperture of the optical lens system is EPD, and following condition is satisfied: EPD=0.16.

In the first embodiment of the present optical lens system, half of the maximum view angle (field of view) of the optical lens system is HFOV, the distance from the image-side surface 132 of the third lens 130 to the image plane 170 along the optical axis 190 is BFL, and following condition is satisfied: sin(HFOV)/(BFL*f)=10.54.

In the first embodiment of the present optical lens system, half of the maximum view angle (field of view) of the optical lens system is HFOV, the distance from the object-side surface 111 of the first lens 110 to the image-side surface 132 of the third lens 130 along the optical axis 190 is TD, the incident pupil aperture of the optical lens system is EPD, and following condition is satisfied: TD/(EPD*sin(HFOV))=6.67.

In the first embodiment of the present optical lens system, half of the maximum view angle (field of view) of the optical lens system is HFOV, a distance from an object-side surface 151 of the flat panel 150 to the object-side surface 111 of the first lens 110 along the optical axis 190 is OPL, and following condition is satisfied: sin(HFOV)/OPL=0.59.

In the first embodiment of the present optical lens system, the distance from the object-side surface 111 of the first lens 110 to the image-side surface 132 of the third lens 130 along the optical axis 190 is TD, a distance from the object-side surface 151 of the flat panel 150 to the image plane 170 along the optical axis 190 is OTL, and following condition is satisfied: TD/OTL=0.35.

In the first embodiment of the present optical lens system, the distance from the object-side surface 151 of the flat panel 150 to the image plane 170 along the optical axis 190 is OTL, the incident pupil aperture of the optical lens system is EPD, and following condition is satisfied: OTL/EPD=19.11.

In the first embodiment of the present optical lens system, the distance from the object-side surface 111 of the first lens 110 to the image-side surface 132 of the third lens 130 along the optical axis 190 is TD, the distance from the object-side surface 151 of the flat panel 150 to the object-side surface 111 of the first lens 110 along the optical axis 190 is OPL, and following condition is satisfied: TD/OPL=0.65.

In the first embodiment of the present optical lens system, the distance from the object-side surface 151 of the flat panel 150 to the image plane 170 along the optical axis 190 is OTL, and following condition is satisfied: OTL=3.15 mm.

In the first embodiment of the present optical lens system, the distance from the object-side surface 151 of the flat panel 150 to the object-side surface 111 of the first lens 110 along the optical axis 190 is OPL, and following condition is satisfied: OPL=1.69 mm.

The detailed optical data of the first embodiment is shown in table 1, and the aspheric surface data is shown in table 2.

TABLE 1
Embodiment 1
f(focal length) = 0.25 mm, Fno = 1.52, FOV = 164.5 deg.

| | | | | | | Index | Abbe # | Focal |
|---|---|---|---|---|---|---|---|---|
| surface | | Curvature Radius | | Thickness/gap | Material | (nd) | (vd) | length |
| 0 | object | infinity | | 0 | | | | |
| 1 | flat panel | infinity | | 1.479 | glass | 1.52 | 64.2 | |
| 2 | | infinity | | 0.207 | | | | |
| 3 | Lens 1 | −27.707 | (ASP) | 0.194 | plastic | 1.54 | 56 | −0.520 |
| 4 | | 0.288 | (ASP) | 0.277 | | | | |
| 5 | stop | infinity | | −0.006 | | | | |
| 6 | Lens 2 | 0.752 | (ASP) | 0.285 | plastic | 1.54 | 56 | 0.682 |
| 7 | | −0.643 | (ASP) | 0.049 | | | | |
| 8 | Lens 3 | 0.451 | (ASP) | 0.290 | plastic | 1.54 | 56 | 0.467 |
| 9 | | −0.457 | (ASP) | 0.165 | | | | |

| | | | | | | |
|---|---|---|---|---|---|---|
| 10 | IR-cut filter | infinity | 0.210 | glass | 1.52 | 64.2 |
| 11 | | infinity | 0 | | | |
| 12 | Image plane | infinity | — | | | |

Note:
reference wavelength is 537 nm

TABLE 2
Aspheric Coefficients

| surface | 3 | 4 | 6 | 7 | 8 | 9 |
|---|---|---|---|---|---|---|
| K: | −8.4708E+01 | −2.7844E−01 | −2.0519E+01 | 4.3517E+00 | −8.5709E+00 | −5.8746E+00 |
| A: | 7.6149E−01 | −1.3630E−01 | 3.1451E+00 | −7.2880E+00 | −1.5129E+00 | 1.9831E+00 |
| B: | −1.2722E−01 | 7.8523E+01 | 3.1980E+00 | 4.5897E+00 | −8.9763E−01 | 2.7190E+00 |
| C: | −1.7195E−01 | 3.3112E+02 | −1.5539E+03 | 1.9543E+02 | −2.5940E+01 | −6.3257E+00 |
| D: | −1.0616E+00 | −1.9507E+03 | −1.8018E+04 | 3.6996E+03 | −6.5649E+02 | −6.8337E+01 |
| E: | 6.3608E−01 | −1.1346E+04 | 2.1944E+05 | 1.5127E+04 | −7.8739E+03 | −2.3846E+02 |
| F: | 2.4799E+00 | −8.2281E+04 | 7.2506E+06 | 9.1168E+04 | −3.8715E+04 | 9.0217E+02 |
| G: | −2.8871E+00 | −3.6784E+06 | 6.4967E+08 | 8.8710E+05 | −6.9035E+05 | 1.9585E+04 |

The units of the radius of curvature, the thickness and the focal length in table 1 are expressed in mm, the surface numbers 0-12 represent the surfaces sequentially arranged from the object-side to the image-side along the optical axis, wherein surface 0 represents a gap between the object O and the object-side surface 151 of the flat panel 150, surface 5 represents a gap between the stop 100 and the object-side surface 121 of the second lens 120, surfaces 1, 3, 6, 8, 10 are thicknesses of the flat panel 150, the first lens 110, the second lens 120, the third lens 130, and the IR-cut filter 160 along the optical axis 190, respectively, surface 2 represents a gap between the flat panel 150 and the first lens 110, surface 4 represents a gap between the first lens 110 and the stop 100, surface 7 represents a gap between the second lens 120 and the third lens 130, surface 9 represents a gap between the third lens 130 and the IR-cut filter 160, surface 11 represents a gap between the IR-cut filter 160 and the image plane 170. In table 2, k represents the conic coefficient of the equation of the aspheric surface profiles, and A, B, C, D, E, F, G . . . : represent the high-order aspheric coefficients. The tables presented below for each embodiment are the corresponding schematic parameter and image plane curves, and the definitions of the tables are the same as Table 1 and Table 2 of the first embodiment. Therefore, an explanation in this regard will not be provided again.

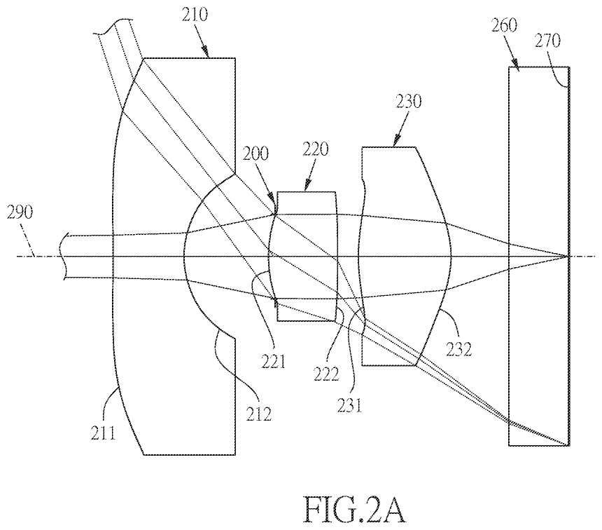

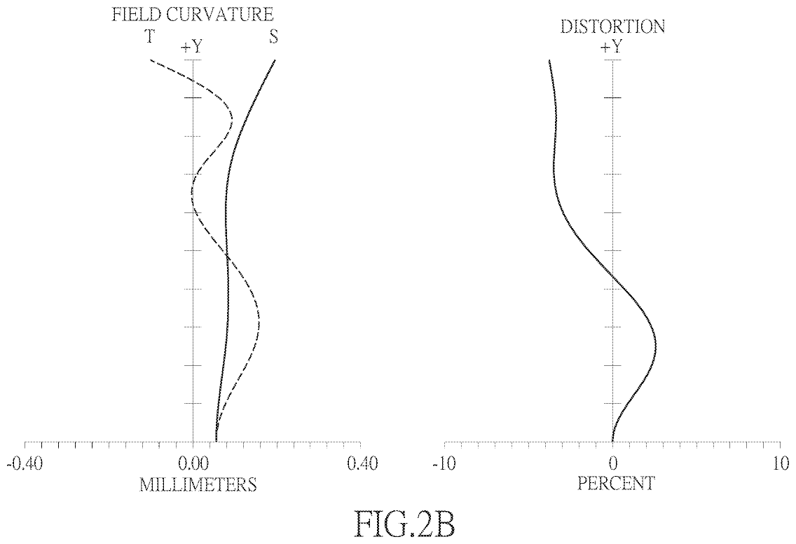

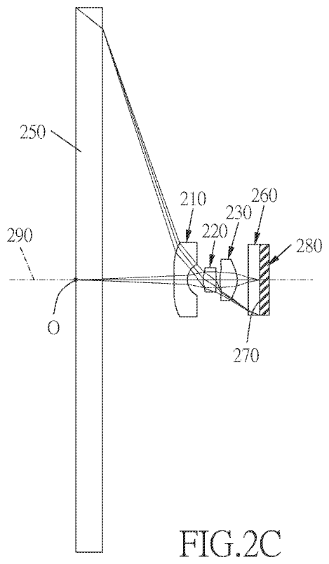

Referring to FIGS. 2A, 2B and 2C, FIG. 2A shows an optical lens system in accordance with a second embodiment of the present invention, FIG. 2B shows, in order from left to right, the image plane curve and the distortion curve of the second embodiment of the present invention, and FIG. 2C shows an imaging device in accordance with the second embodiment of the present invention. An optical lens system in accordance with the second embodiment of the present invention comprises, in order from an object side to an image side: a first lens 210, a stop 200, a second lens 220, a third lens 230, an IR-cut filter 260, and an image plane 270. Preferably, the optical lens system has a total of three lenses with refractive power, but not limited to this. An imaging device in accordance with the second embodiment of the present invention comprises, in order from the object side to the image side: a flat panel 250, the above optical lens system (not shown), and an image sensor 280. The image sensor 280 is disposed on the image plane 270.

The flat panel 250 made of glass is located between an object O and the first lens 210 and has no influence on the focal length of the optical lens system. The flat panel 250 can be made of other materials.

The first lens 210 with negative refractive power, comprising an object-side surface 211 and an image-side surface 212, the object-side surface 211 of the first lens 210 being concave near an optical axis 290 and the image-side surface 212 of the first lens 210 being concave near the optical axis 290, the object-side surface 211 and the image-side surface 212 of the first lens 210 are aspheric, and the first lens 210 is made of plastic material.

The second lens 220 with positive refractive power, comprising an object-side surface 221 and an image-side surface 222, the object-side surface 221 of the second lens 220 being convex near the optical axis 290 and the image-side surface 222 of the second lens 220 being concave near the optical axis 290, the object-side surface 221 and the image-side surface 222 of the second lens 220 are aspheric, and the second lens 220 is made of plastic material.

The third lens 230 with positive refractive power, comprising an object-side surface 231 and an image-side surface 232, the object-side surface 231 of the third lens 230 being convex near the optical axis 290 and the image-side surface 232 of the third lens 230 being convex near the optical axis 290, the object-side surface 231 and the image-side surface 232 of the third lens 230 are aspheric, and the third lens 230 is made of plastic material.

The IR-cut filter 260 made of glass is located between the third lens 230 and the image plane 270 and has no influence on the focal length of the optical lens system. The IR-cut filter 260 can also be formed on the surfaces of the lenses and made of other materials.

The detailed optical data of the second embodiment is shown in table 3, and the aspheric surface data is shown in table 4.

TABLE 3
Embodiment 2
f(focal length) = 0.27 mm, Fno = 1.52, FOV = 141.6 deg.

| | | | | | | Index | Abbe # | Focal |
|---|---|---|---|---|---|---|---|---|
| surface | | Curvature Radius | | Thickness/gap | Material | (nd) | (vd) | length |
| 0 | object | infinity | | 0 | | | | |
| 1 | flat panel | infinity | | 0.500 | glass | 1.52 | 64.2 | |
| 2 | | infinity | | 1.323 | | | | |
| 3 | Lens 1 | −10.107 | (ASP) | 0.241 | plastic | 1.54 | 56 | −0.513 |
| 4 | | 0.291 | (ASP) | 0.316 | | | | |
| 5 | stop | infinity | | −0.018 | | | | |
| 6 | Lens 2 | 0.498 | (ASP) | 0.242 | plastic | 1.54 | 56 | 0.917 |
| 7 | | 53.470 | (ASP) | 0.068 | | | | |
| 8 | Lens 3 | 0.504 | (ASP) | 0.325 | plastic | 1.54 | 56 | 0.429 |
| 9 | | −0.339 | (ASP) | 0.200 | | | | |

| | | | | | | |
|---|---|---|---|---|---|---|
| 10 | IR-cut filter | infinity | 0.210 | glass | 1.52 | 64.2 |
| 11 | | infinity | 0 | | | |
| 12 | Image plane | infinity | — | | | |

Note:
reference wavelength is 537 nm

TABLE 4
Aspheric Coefficients

| surface | 3 | 4 | 6 | 7 | 8 | 9 |
|---|---|---|---|---|---|---|
| K: | 8.0789E+01 | −2.7247E−01 | −2.4936E+00 | 1.0001E+02 | −2.1295E+01 | −2.8966E+00 |
| A: | 7.8395E−01 | −5.5342E+00 | 5.4471E+00 | −1.1078E+01 | −4.2611E−01 | 1.9537E+00 |
| B: | −1.4595E−01 | 6.2278E+01 | −5.9140E+00 | 5.2536E+01 | −4.2610E+00 | 4.1152E+00 |
| C: | −1.7725E−01 | 4.6618E+02 | −8.3366E+02 | 5.3966E+02 | −2.4765E+02 | −1.5437E+01 |
| D: | −1.1761E+00 | −3.9544E+01 | 2.1041E+04 | 3.7301E+03 | −3.5689E+03 | −3.1836E+02 |
| E: | 4.5809E−01 | 3.7097E+03 | 1.0394E+06 | −3.9003E+04 | −4.0504E+04 | −2.6266E+03 |
| F: | 2.0683E+00 | −1.1494E+05 | 1.4103E+07 | −4.4109E+05 | −2.3842E+05 | −1.1419E+04 |
| G: | −3.6988E+00 | −6.9666E+06 | −1.2712E+09 | 4.8050E+07 | −3.9806E+06 | 1.9183E+05 |

In the second embodiment, the equation of the aspheric surface profiles of the aforementioned lenses is the same as the equation of the first embodiment. Also, the definitions of these parameters shown in the following table are the same as those stated in the first embodiment with corresponding values for the second embodiment, so an explanation in this regard will not be provided again.

Moreover, these parameters can be calculated from Table 3 and Table 4 as the following values and satisfy the following conditions:

Embodiment 2

| | | | |
|---|---|---|---|
| f[mm] | 0.27 | TD/OPL | 0.64 |
| Fno | 1.52 | TD/BFL | 2.86 |
| FOV[deg.] | 141.60 | TD/EPD | 6.54 |
| EPD | 0.18 | sin(HFOV)/EPD | 5.27 |
| TD/OTL | 0.34 | OTL[mm] | 3.41 |
| OTL/EPD | 19.0 | OPL[mm] | 1.82 |
| sin(HFOV)/OPL | 0.52 | BFL[mm] | 0.41 |
| sin(HFOV)/(BFL*f) | 8.45 | TD/(EPD*sin(HFOV)) | 6.93 |

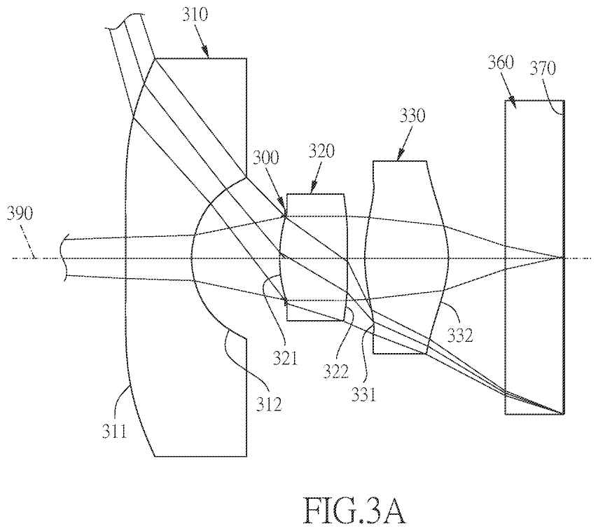

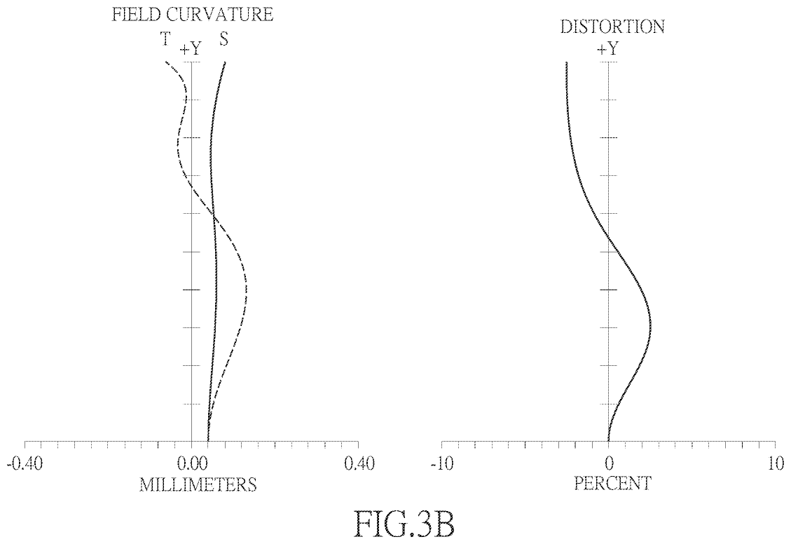

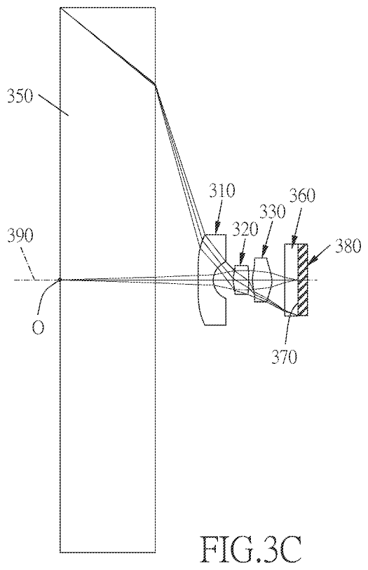

Referring to FIGS. 3A, 3B and 3C, FIG. 3A shows an optical lens system in accordance with a third embodiment of the present invention, FIG. 3B shows, in order from left to right, the image plane curve and the distortion curve of the third embodiment of the present invention, and FIG. 3C shows an imaging device in accordance with the third embodiment of the present invention. An optical lens system in accordance with the third embodiment of the present invention comprises, in order from an object side to an image side: a first lens 310, a stop 300, a second lens 320, a third lens 330, an IR-cut filter 360, and an image plane 370. The optical lens system has a total of three lenses with refractive power, but not limited to this. An imaging device in accordance with the third embodiment of the present invention comprises, in order from the object side to the image side: a flat panel 350, the above optical lens system (not shown), and an image sensor 380. The image sensor 380 is disposed on the image plane 370.

The flat panel 350 made of glass is located between an object O and the first lens 310 and has no influence on the focal length of the optical lens system. The flat panel 350 can be made of other materials.

The first lens 310 with negative refractive power, comprising an object-side surface 311 and an image-side surface 312, the object-side surface 311 of the first lens 310 being concave near an optical axis 390 and the image-side surface 312 of the first lens 310 being concave near the optical axis 390, the object-side surface 311 and the image-side surface 312 of the first lens 310 are aspheric, and the first lens 310 is made of plastic material.

The second lens 320 with positive refractive power, comprising an object-side surface 321 and an image-side surface 322, the object-side surface 321 of the second lens 320 being convex near the optical axis 390 and the image-side surface 322 of the second lens 320 being concave near the optical axis 390, the object-side surface 321 and the image-side surface 322 of the second lens 320 are aspheric, and the second lens 320 is made of plastic material.

The third lens 330 with positive refractive power, comprising an object-side surface 331 and an image-side surface 332, the object-side surface 331 of the third lens 330 being convex near the optical axis 390 and the image-side surface 332 of the third lens 330 being convex near the optical axis 390, the object-side surface 331 and the image-side surface 332 of the third lens 330 are aspheric, and the third lens 330 is made of plastic material.

The IR-cut filter 360 made of glass is located between the third lens 330 and the image plane 370 and has no influence on the focal length of the optical lens system. The IR-cut filter 360 can also be formed on the surfaces of the lenses and made of other materials.

The detailed optical data of the third embodiment is shown in table 5, and the aspheric surface data is shown in table 6.

TABLE 5
Embodiment 3
f(focal length) = 0.27 mm, Fno = 1.52, FOV = 146.0 deg.

| | | | | | | Index | Abbe # | Focal |
|---|---|---|---|---|---|---|---|---|
| surface | | Curvature Radius | | Thickness/gap | Material | (nd) | (vd) | length |
| 0 | object | infinity | | 0 | | | | |
| 1 | flat panel | infinity | | 1.479 | glass | 1.52 | 64.2 | |
| 2 | | infinity | | 0.673 | | | | |
| 3 | Lens 1 | −9.115 | (ASP) | 0.227 | plastic | 1.54 | 56 | −0.512 |
| 4 | | 0.292 | (ASP) | 0.332 | | | | |
| 5 | stop | infinity | | −0.018 | | | | |
| 6 | Lens 2 | 0.500 | (ASP) | 0.242 | plastic | 1.54 | 56 | 0.919 |
| 7 | | 89.787 | (ASP) | 0.055 | | | | |
| 8 | Lens 3 | 0.428 | (ASP) | 0.297 | plastic | 1.54 | 56 | 0.428 |
| 9 | | −0.389 | (ASP) | 0.202 | | | | |

| | | | | | | |
|---|---|---|---|---|---|---|
| 10 | IR-cut filter | infinity | 0.210 | glass | 1.52 | 64.2 |
| 11 | | infinity | 0 | | | |
| 12 | Image plane | infinity | — | | | |

Note:
reference wavelength is 537 nm

TABLE 6
Aspheric Coefficients

| surface | 3 | 4 | 6 | 7 | 8 | 9 |
|---|---|---|---|---|---|---|
| K: | 9.8257E+01 | −2.5401E−01 | −2.5145E+00 | 8.9094E+01 | −1.4065E+01 | −4.3052E+00 |
| A: | 7.5054E−01 | −3.9784E+00 | 5.4150E+00 | −1.2029E+01 | 1.2780E−01 | 2.3020E+00 |
| B: | −1.6342E−01 | 7.1487E+01 | −8.9878E+00 | 5.4618E+01 | 2.2892E−01 | 4.9806E+00 |
| C: | −1.8791E−01 | 5.2238E+02 | −9.2872E+02 | 6.4101E+02 | −1.9201E+02 | −1.1657E+01 |
| D: | −1.1018E+00 | 2.4447E+02 | 1.9418E+04 | 4.9007E+03 | −2.6535E+03 | −2.8611E+02 |
| E: | 5.6165E−01 | 3.9669E+03 | 1.0413E+06 | −3.4698E+04 | −2.5845E+04 | −2.3117E+03 |
| F: | 2.4114E+00 | −1.3719E+05 | 1.5708E+07 | −6.5124E+05 | −3.0153E+04 | −8.4875E+03 |
| G: | −2.7567E+00 | −7.3636E+06 | −1.1881E+09 | 3.9732E+07 | −1.3859E+06 | 2.1744E+05 |

In the third embodiment, the equation of the aspheric surface profiles of the aforementioned lenses is the same as the equation of the first embodiment. Also, the definitions of these parameters shown in the following table are the same as those stated in the first embodiment with corresponding values for the third embodiment, so an explanation in this regard will not be provided again.

Moreover, these parameters can be calculated from Table 5 and Table 6 as the following values and satisfy the following conditions:

Embodiment 3

| | | | |
|---|---|---|---|
| f[mm] | 0.27 | TD/OPL | 0.53 |
| Fno | 1.52 | TD/BFL | 2.76 |
| FOV[deg.] | 146.00 | TD/EPD | 6.47 |
| EPD | 0.18 | sin(HFOV)/EPD | 5.45 |
| TD/OTL | 0.31 | OTL[mm] | 3.70 |
| OTL/EPD | 21.07 | OPL[mm] | 2.15 |
| sin(HFOV)/OPL | 0.44 | BFL[mm] | 0.41 |
| sin(HFOV)/(BFL*f) | 8.70 | TD/(EPD*sin(HFOV)) | 6.77 |

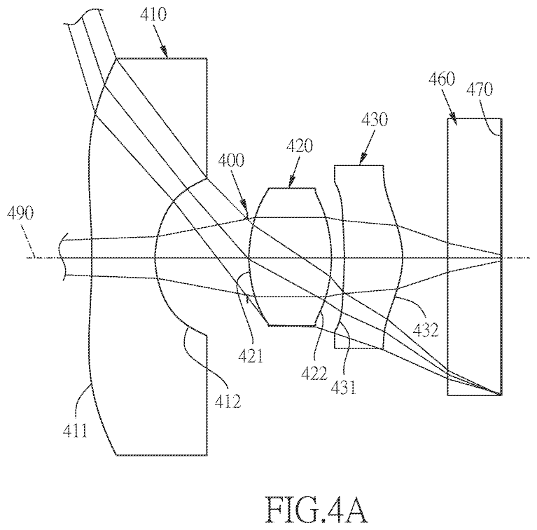

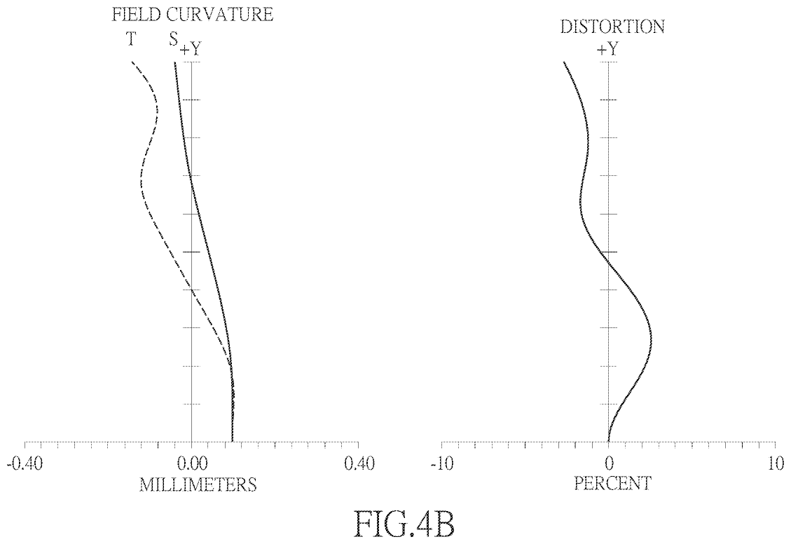

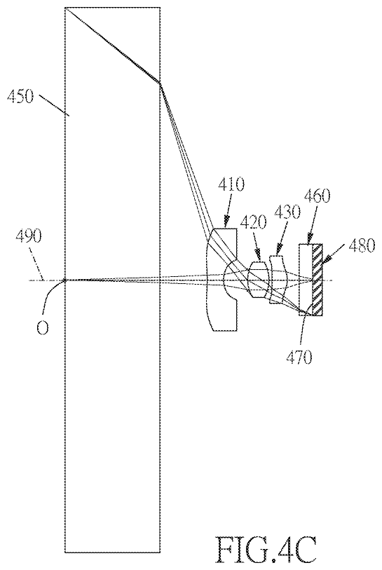

Referring to FIGS. 4A, 4B and 4C, FIG. 4A shows an optical lens system in accordance with a fourth embodiment of the present invention, FIG. 4B shows, in order from left to right, the image plane curve and the distortion curve of the fourth embodiment of the present invention, and FIG. 4C shows an imaging device in accordance with the fourth embodiment of the present invention. An optical lens system in accordance with the fourth embodiment of the present invention comprises, in order from an object side to an image side: a first lens 410, a stop 400, a second lens 420, a third lens 430, an IR-cut filter 460, and an image plane 470. The optical lens system has a total of three lenses with refractive power, but not limited to this. An imaging device in accordance with the fourth embodiment of the present invention comprises, in order from the object side to the image side: a flat panel 450, the above optical lens system (not shown), and an image sensor 480. The image sensor 480 is disposed on the image plane 470.

The flat panel 450 made of glass is located between an object O and the first lens 410 and has no influence on the focal length of the optical lens system. The flat panel 450 can be made of other materials.

The first lens 410 with negative refractive power, comprising an object-side surface 411 and an image-side surface 412, the object-side surface 411 of the first lens 410 being concave near an optical axis 490 and the image-side surface 412 of the first lens 410 being concave near the optical axis 490, the object-side surface 411 and the image-side surface 412 of the first lens 410 are aspheric, and the first lens 410 is made of plastic material.

The second lens 420 with positive refractive power, comprising an object-side surface 421 and an image-side surface 422, the object-side surface 421 of the second lens 420 being convex near the optical axis 490 and the image-side surface 422 of the second lens 420 being convex near the optical axis 490, the object-side surface 421 and the image-side surface 422 of the second lens 420 are aspheric, and the second lens 420 is made of plastic material.

The third lens 430 with positive refractive power, comprising an object-side surface 431 and an image-side surface 432, the object-side surface 431 of the third lens 430 being concave near the optical axis 490 and the image-side surface 432 of the third lens 430 being convex near the optical axis 490, the object-side surface 431 and the image-side surface 432 of the third lens 430 are aspheric, and the third lens 430 is made of plastic material.

The IR-cut filter 460 made of glass is located between the third lens 430 and the image plane 470 and has no influence on the focal length of the optical lens system. The IR-cut filter 460 can also be formed on the surfaces of the lenses and made of other materials.

The detailed optical data of the fourth embodiment is shown in table 7, and the aspheric surface data is shown in table 8.

TABLE 7
Embodiment 4
f(focal length) = 0.29 mm, Fno = 1.58, FOV = 143.1 deg.

| | | | | | | Index | Abbe # | Focal |
|---|---|---|---|---|---|---|---|---|
| surface | | Curvature Radius | | Thickness/gap | Material | (nd) | (vd) | length |
| 0 | object | infinity | | 0 | | | | |
| 1 | flat panel | infinity | | 1.479 | glass | 1.52 | 64.2 | |
| 2 | | infinity | | 0.734 | | | | |
| 3 | Lens 1 | −2.401 | (ASP) | 0.254 | plastic | 1.54 | 56 | −0.564 |
| 4 | | 0.367 | (ASP) | 0.366 | | | | |
| 5 | stop | infinity | | 0.006 | | | | |
| 6 | Lens 2 | 0.431 | (ASP) | 0.334 | plastic | 1.54 | 56 | 0.504 |
| 7 | | −0.555 | (ASP) | 0.054 | | | | |
| 8 | Lens 3 | −1.156 | (ASP) | 0.234 | plastic | 1.54 | 56 | 0.748 |
| 9 | | −0.324 | (ASP) | 0.182 | | | | |

| | | | | | | |
|---|---|---|---|---|---|---|
| 10 | IR-cut filter | infinity | 0.210 | glass | 1.52 | 64.2 |
| 11 | | infinity | 0 | | | |
| 12 | Image plane | infinity | — | | | |

Note:
reference wavelength is 537 nm

TABLE 8
Aspheric Coefficients

| surface | 3 | 4 | 6 | 7 | 8 | 9 |
|---|---|---|---|---|---|---|
| K: | −3.0074E+01 | −4.2651E−01 | −1.1181E+01 | 2.3014E+00 | −1.0001E+02 | −4.2656E+00 |
| A: | 6.9516E−01 | −2.7971E+00 | 3.6637E+00 | −6.1735E−01 | 2.4729E+00 | 1.9247E+00 |
| B: | −1.3862E−01 | 5.9420E+01 | 4.8235E+01 | 7.5625E+01 | −1.3240E+01 | 2.8004E+00 |
| C: | −1.7636E−01 | 3.4268E+02 | 1.4588E+01 | −4.0629E+02 | −2.8054E+02 | 2.5763E+01 |
| D: | −1.0751E+00 | −2.2892E+02 | 2.6110E+03 | −6.7369E+03 | −5.4167E+03 | 2.0285E+02 |
| E: | 6.2155E−01 | 1.4257E+04 | −5.2628E+04 | −6.7618E+04 | −4.2013E+04 | 1.3711E+03 |
| F: | 2.4582E+00 | 1.6857E+05 | −2.4166E+06 | 6.2271E+05 | 3.2769E+05 | 7.0545E+03 |
| G: | −2.2915E+00 | −3.3789E+06 | 2.8177E+07 | 3.1526E+07 | 5.9486E+06 | −2.2488E+05 |

In the fourth embodiment, the equation of the aspheric surface profiles of the aforementioned lenses is the same as the equation of the first embodiment. Also, the definitions of these parameters shown in the following table are the same as those stated in the first embodiment with corresponding values for the fourth embodiment, so an explanation in this regard will not be provided again.

Moreover, these parameters can be calculated from Table 7 and Table 8 as the following values and satisfy the following conditions:

Embodiment 4

| | | | |
|---|---|---|---|
| f[mm] | 0.29 | TD/OPL | 0.56 |
| Fno | 1.58 | TD/BFL | 3.18 |
| FOV[deg.] | 143.10 | TD/EPD | 6.88 |
| EPD | 0.18 | sin(HFOV)/EPD | 5.23 |
| TD/OTL | 0.32 | OTL[mm] | 3.85 |
| OTL/EPD | 21.24 | OPL[mm] | 2.21 |
| sin(HFOV)/OPL | 0.43 | BFL[mm] | 0.39 |
| sin(HFOV)/(BFL*f) | 8.43 | TD/(EPD*sin(HFOV)) | 7.25 |

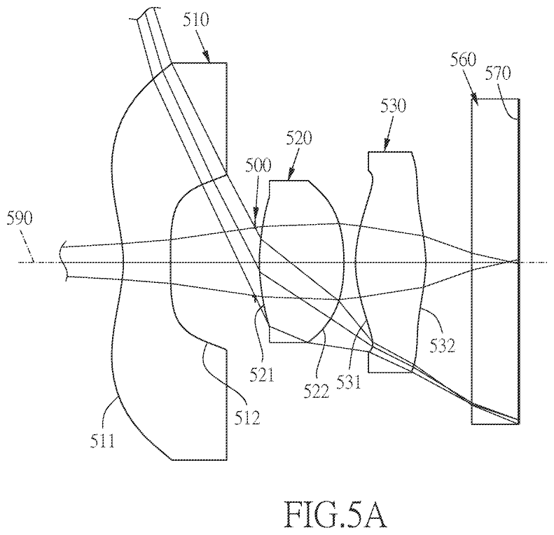

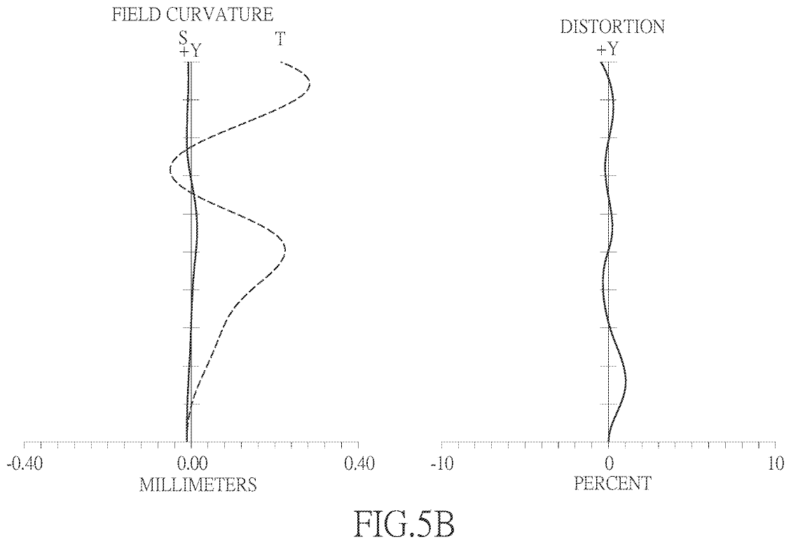

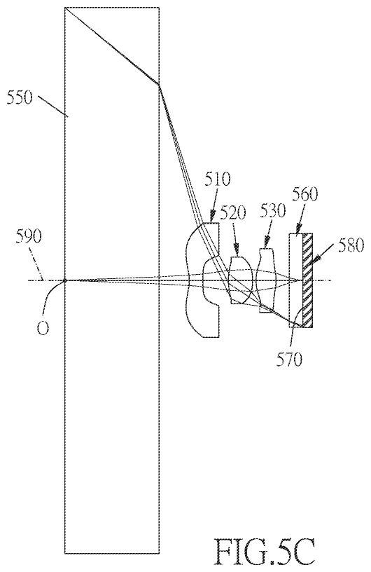

Referring to FIGS. 5A, 5B and 5C, FIG. 5A shows an optical lens system in accordance with a fifth embodiment of the present invention, FIG. 5B shows, in order from left to right, the image plane curve and the distortion curve of the fifth embodiment of the present invention, and FIG. 5C shows an imaging device in accordance with the fifth embodiment of the present invention. An optical lens system in accordance with the fifth embodiment of the present invention comprises, in order from an object side to an image side: a first lens 510, a stop 500, a second lens 520, a third lens 530, an IR-cut filter 560, and an image plane 570. The optical lens system has a total of three lenses with refractive power, but not limited to this. An imaging device in accordance with the fifth embodiment of the present invention comprises, in order from the object side to the image side: a flat panel 550, the above optical lens system (not shown), and an image sensor 580. The image sensor 580 is disposed on the image plane 570.

The flat panel 550 made of glass is located between an object O and the first lens 510 and has no influence on the focal length of the optical lens system. The flat panel 550 can be made of other materials.

The first lens 510 with negative refractive power, comprising an object-side surface 511 and an image-side surface 512, the object-side surface 511 of the first lens 510 being concave near an optical axis 590 and the image-side surface 512 of the first lens 510 being convex near the optical axis 590, the object-side surface 511 and the image-side surface 512 of the first lens 510 are aspheric, and the first lens 510 is made of plastic material.

The second lens 520 with positive refractive power, comprising an object-side surface 521 and an image-side surface 522, the object-side surface 521 of the second lens 520 being convex near the optical axis 590 and the image-side surface 522 of the second lens 520 being convex near the optical axis 590, the object-side surface 521 and the image-side surface 522 of the second lens 520 are aspheric, and the second lens 520 is made of plastic material.

The third lens 530 with positive refractive power, comprising an object-side surface 531 and an image-side surface 532, the object-side surface 531 of the third lens 530 being convex near the optical axis 590 and the image-side surface 532 of the third lens 530 being convex near the optical axis 590, the object-side surface 531 and the image-side surface 532 of the third lens 530 are aspheric, and the third lens 530 is made of plastic material.

The IR-cut filter 560 made of glass is located between the third lens 530 and the image plane 570 and has no influence on the focal length of the optical lens system. The IR-cut filter 560 can also be formed on the surfaces of the lenses and made of other materials.

The detailed optical data of the fifth embodiment is shown in table 9, and the aspheric surface data is shown in table 10.

TABLE 9
Embodiment 5
f(focal length) = 0.30 mm, Fno = 1.48, FOV = 146.7 deg.

| | | | | | | Index | Abbe # | Focal |
|---|---|---|---|---|---|---|---|---|
| surface | | Curvature Radius | | Thickness/gap | Material | (nd) | (vd) | length |
| 0 | object | infinity | | 0 | | | | |
| 1 | flat panel | infinity | | 1.479 | glass | 1.52 | 64.2 | |
| 2 | | infinity | | 0.474 | | | | |
| 3 | Lens 1 | −0.562 | (ASP) | 0.212 | plastic | 1.54 | 56 | −1.048 |
| 4 | | −30.001 | (ASP) | 0.379 | | | | |
| 5 | stop | infinity | | 0.024 | | | | |
| 6 | Lens 2 | 0.896 | (ASP) | 0.378 | plastic | 1.54 | 56 | 0.847 |
| 7 | | −0.818 | (ASP) | 0.055 | | | | |
| 8 | Lens 3 | 0.549 | (ASP) | 0.312 | plastic | 1.54 | 56 | 0.573 |
| 9 | | −0.584 | (ASP) | 0.211 | | | | |

| | | | | | | |
|---|---|---|---|---|---|---|
| 10 | IR-cut filter | infinity | 0.210 | glass | 1.52 | 64.2 |
| 11 | | infinity | 0 | | | |
| 12 | Image plane | infinity | — | | | |

Note:
reference wavelength is 537 nm

TABLE 10
Aspheric Coefficients

| surface | 3 | 4 | 6 | 7 | 8 | 9 |
|---|---|---|---|---|---|---|
| K: | −1.4390E+01 | 1.0005E+02 | −2.8811E+01 | 3.1731E+00 | −3.6712E+00 | −8.4050E+00 |
| A: | 1.0281E+00 | 1.1078E+01 | 1.4552E+00 | −4.2029E+00 | −1.6565E+00 | 2.9701E+00 |
| B: | −6.1389E−01 | −1.1684E+02 | 1.9839E+01 | 1.0343E+01 | 6.2116E+00 | −2.3902E+00 |
| C: | 2.7165E−01 | 9.6616E+02 | −4.7411E+02 | −3.5443E+01 | 1.7134E+01 | −2.6477E+01 |
| D: | −6.5836E−01 | 4.8412E+02 | −2.5722E+02 | 9.5350E+02 | −3.7695E+02 | −5.6360E+01 |
| E: | 5.0511E−01 | −8.7860E+03 | 6.1064E+04 | −7.9079E+03 | −1.6099E+03 | 1.7041E+01 |
| F: | 2.1531E+00 | 8.2731E+04 | −1.9044E+05 | −7.9071E+04 | 4.1648E+04 | 9.8617E+02 |
| G: | −2.3272E+00 | −6.7488E+05 | −1.2221E+06 | 7.7859E+05 | −2.2278E+05 | −2.5969E+01 |

In the fifth embodiment, the equation of the aspheric surface profiles of the aforementioned lenses is the same as the equation of the first embodiment. Also, the definitions of these parameters shown in the following table are the same as those stated in the first embodiment with corresponding values for the fifth embodiment, so an explanation in this regard will not be provided again.

Moreover, these parameters can be calculated from Table 9 and Table 10 as the following values and satisfy the following conditions:

Embodiment 5

| | | | |
|---|---|---|---|
| f[mm] | 0.30 | TD/OPL | 0.70 |
| Fno | 1.48 | TD/BFL | 3.23 |
| FOV[deg.] | 146.70 | TD/EPD | 6.78 |
| EPD | 0.20 | sin(HFOV)/EPD | 4.78 |
| TD/OTL | 0.36 | OTL[mm] | 3.73 |
| OTL/EPD | 18.62 | OPL[mm] | 1.95 |
| sin(HFOV)/OPL | 0.49 | BFL[mm] | 0.42 |
| sin(HFOV)/(BFL*f) | 7.68 | TD/(EPD*sin(HFOV)) | 7.08 |

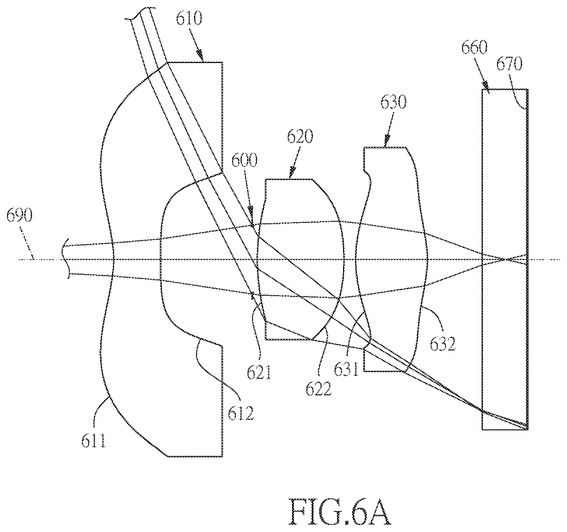

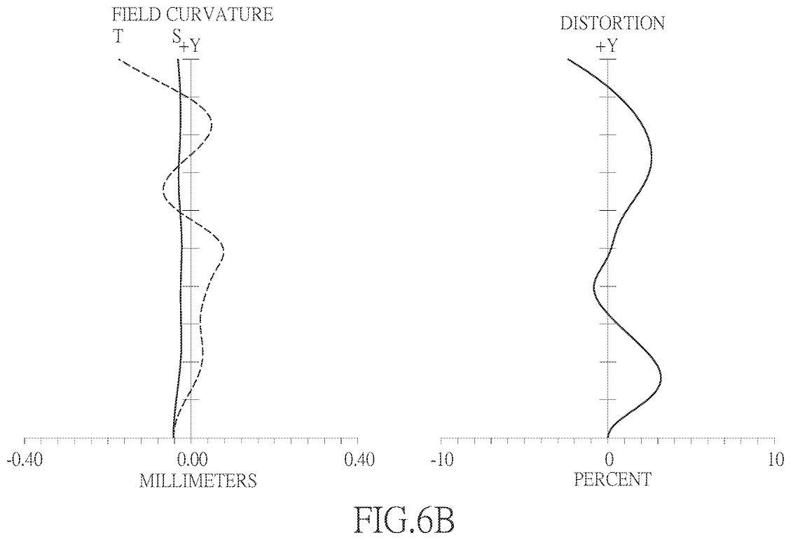

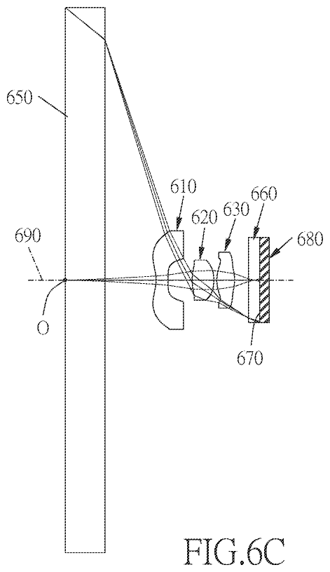

Referring to FIGS. 6A, 6B and 6C, FIG. 6A shows an optical lens system in accordance with a sixth embodiment of the present invention, FIG. 6B shows, in order from left to right, the image plane curve and the distortion curve of the sixth embodiment of the present invention, and FIG. 6C shows an imaging device in accordance with the sixth embodiment of the present invention. An optical lens system in accordance with the sixth embodiment of the present invention comprises, in order from an object side to an image side: a first lens 610, a stop 600, a second lens 620, a third lens 630, an IR-cut filter 660, and an image plane 670. The optical lens system has a total of three lenses with refractive power, but not limited to this. An imaging device in accordance with the sixth embodiment of the present invention comprises, in order from the object side to the image side: a flat panel 650, the above optical lens system (not shown), and an image sensor 680. The image sensor 680 is disposed on the image plane 670.

The flat panel 650 made of glass is located between an object O and the first lens 610 and has no influence on the focal length of the optical lens system. The flat panel 650 can be made of other materials.

The first lens 610 with negative refractive power, comprising an object-side surface 611 and an image-side surface 612, the object-side surface 611 of the first lens 610 being concave near an optical axis 690 and the image-side surface 612 of the first lens 610 being convex near the optical axis 690, the object-side surface 611 and the image-side surface 612 of the first lens 610 are aspheric, and the first lens 610 is made of plastic material.

The second lens 620 with positive refractive power, comprising an object-side surface 621 and an image-side surface 622, the object-side surface 621 of the second lens 620 being convex near the optical axis 690 and the image-side surface 622 of the second lens 620 being convex near the optical axis 690, the object-side surface 621 and the image-side surface 622 of the second lens 620 are aspheric, and the second lens 620 is made of plastic material.

The third lens 630 with positive refractive power, comprising an object-side surface 631 and an image-side surface 632, the object-side surface 631 of the third lens 630 being convex near the optical axis 690 and the image-side surface 632 of the third lens 630 being convex near the optical axis 690, the object-side surface 631 and the image-side surface 632 of the third lens 630 are aspheric, and the third lens 630 is made of plastic material.

The IR-cut filter 660 made of glass is located between the third lens 630 and the image plane 670 and has no influence on the focal length of the optical lens system. The IR-cut filter 660 can also be formed on the surfaces of the lenses and made of other materials.

The detailed optical data of the sixth embodiment is shown in table 11, and the aspheric surface data is shown in table 12.

TABLE 11
Embodiment 6
f(focal length) = 0.28 mm, Fno = 1.48, FOV = 143.7 deg.

| | | | | | | Index | Abbe # | Focal |
|---|---|---|---|---|---|---|---|---|
| surface | | Curvature Radius | | Thickness/gap | Material | (nd) | (vd) | length |
| 0 | object | infinity | | 0 | | | | |
| 1 | flat panel | infinity | | 0.737 | glass | 1.52 | 64.2 | |
| 2 | | infinity | | 0.954 | | | | |
| 3 | Lens 1 | −0.496 | (ASP) | 0.213 | plastic | 1.54 | 56 | −0.925 |
| 4 | | −30.041 | (ASP) | 0.427 | | | | |
| 5 | stop | infinity | | 0.022 | | | | |
| 6 | Lens 2 | 0.861 | (ASP) | 0.404 | plastic | 1.54 | 56 | 0.868 |
| 7 | | −0.885 | (ASP) | 0.059 | | | | |
| 8 | Lens 3 | 0.644 | (ASP) | 0.333 | plastic | 1.54 | 56 | 0.562 |
| 9 | | −0.480 | (ASP) | 0.253 | | | | |

| | | | | | | |
|---|---|---|---|---|---|---|
| 10 | IR-cut filter | infinity | 0.210 | glass | 1.52 | 64.2 |
| 11 | | infinity | 0 | | | |
| 12 | Image plane | infinity | — | | | |

Note:
reference wavelength is 537 nm

TABLE 12
Aspheric Coefficients

| surface | 3 | 4 | 6 | 7 | 8 | 9 |
|---|---|---|---|---|---|---|
| K: | −1.1550E+01 | −1.0067E+02 | −2.9134E+01 | 3.2344E+00 | −3.3645E+00 | −9.4432E+00 |
| A: | 1.0811E+00 | 1.1776E+01 | 1.3092E+00 | −3.9116E+00 | −1.0152E+00 | 2.7687E+00 |
| B: | −6.1637E−01 | −1.2142E+02 | 2.3006E+01 | 1.1513E+01 | 3.6081E+00 | −3.5093E+00 |
| C: | 2.5672E−01 | 9.6774E+02 | −4.2602E+02 | −3.4669E+01 | 2.5208E+00 | −2.6268E+01 |
| D: | −6.8139E−01 | 5.1816E+02 | −1.5277E+02 | 9.2400E+02 | −4.4162E+02 | −4.3137E+01 |
| E: | 4.9052E−01 | −8.5833E+03 | 5.6890E+04 | −8.2291E+03 | −1.7464E+03 | 6.7663E+01 |
| F: | 2.1733E+00 | 8.5097E+04 | −2.3927E+05 | −8.2117E+04 | 4.2912E+04 | 9.9107E+02 |
| G: | −2.2464E+00 | −6.4582E+05 | −7.4369E+05 | 7.4470E+05 | −2.1041E+05 | −1.3889E+03 |

In the sixth embodiment, the equation of the aspheric surface profiles of the aforementioned lenses is the same as the equation of the first embodiment. Also, the definitions of these parameters shown in the following table are the same as those stated in the first embodiment with corresponding values for the sixth embodiment, so an explanation in this regard will not be provided again.

Moreover, these parameters can be calculated from Table 11 and Table 12 as the following values and satisfy the following conditions:

Embodiment 6

| | | | |
|---|---|---|---|
| f[mm] | 0.28 | TD/OPL | 0.86 |
| Fno | 1.48 | TD/BFL | 3.15 |
| FOV[deg.] | 143.70 | TD/EPD | 7.70 |
| EPD | 0.19 | sin(HFOV)/EPD | 5.02 |
| TD/OTL | 0.40 | OTL[mm] | 3.61 |
| OTL/EPD | 19.07 | OPL[mm] | 1.69 |
| sin(HFOV)/OPL | 0.56 | BFL[mm] | 0.46 |
| sin(HFOV)/(BFL*f) | 7.33 | TD/(EPD*sin(HFOV)) | 8.11 |

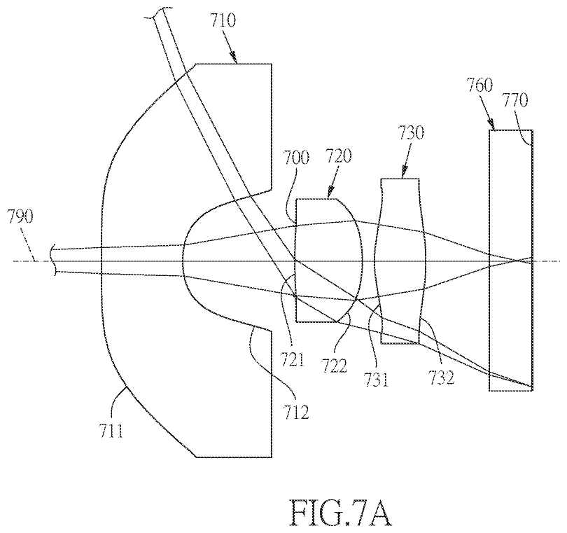

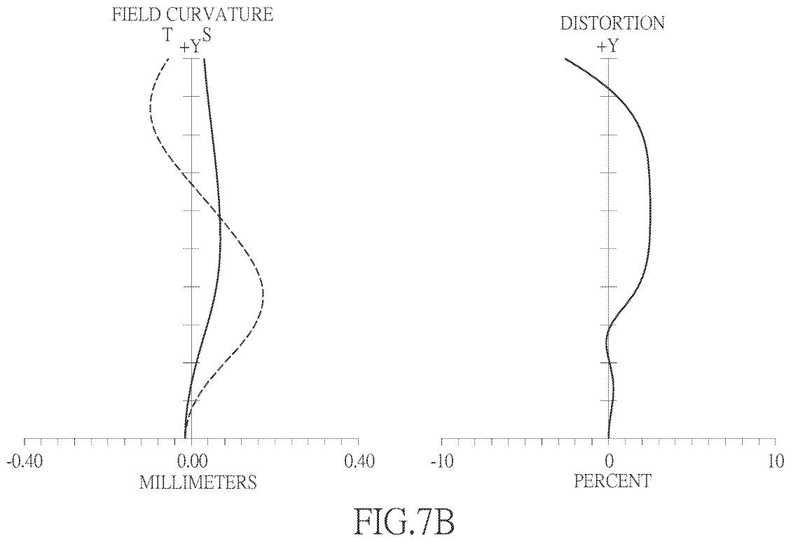

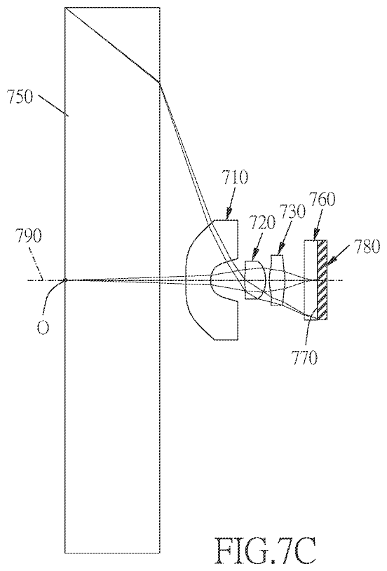

Referring to FIGS. 7A, 7B and 7C, FIG. 7A shows an optical lens system in accordance with a seventh embodiment of the present invention, FIG. 7B shows, in order from left to right, the image plane curve and the distortion curve of the seventh embodiment of the present invention, and FIG. 7C shows an imaging device in accordance with the seventh embodiment of the present invention. An optical lens system in accordance with the seventh embodiment of the present invention comprises, in order from an object side to an image side: a first lens 710, a stop 700, a second lens 720, a third lens 730, an IR-cut filter 760, and an image plane 770. The optical lens system has a total of three lenses with refractive power, but not limited to this. An imaging device in accordance with the seventh embodiment of the present invention comprises, in order from the object side to the image side: a flat panel 750, the above optical lens system (not shown), and an image sensor 780. The image sensor 780 is disposed on the image plane 770.

The flat panel 750 made of glass is located between an object O and the first lens 710 and has no influence on the focal length of the optical lens system. The flat panel 750 can be made of other materials.

The first lens 710 with negative refractive power, comprising an object-side surface 711 and an image-side surface 712, the object-side surface 711 of the first lens 710 being concave near an optical axis 790 and the image-side surface 712 of the first lens 710 being concave near the optical axis 790, the object-side surface 711 and the image-side surface 712 of the first lens 710 are aspheric, and the first lens 710 is made of plastic material.

The second lens 720 with positive refractive power, comprising an object-side surface 721 and an image-side surface 722, the object-side surface 721 of the second lens 720 being convex near the optical axis 790 and the image-side surface 722 of the second lens 720 being convex near the optical axis 790, the object-side surface 721 and the image-side surface 722 of the second lens 720 are aspheric, and the second lens 720 is made of plastic material.

The third lens 730 with positive refractive power, comprising an object-side surface 731 and an image-side surface 732, the object-side surface 731 of the third lens 730 being convex near the optical axis 790 and the image-side surface 732 of the third lens 730 being convex near the optical axis 790, the object-side surface 731 and the image-side surface 732 of the third lens 730 are aspheric, and the third lens 730 is made of plastic material.

The IR-cut filter 760 made of glass is located between the third lens 730 and the image plane 770 and has no influence on the focal length of the optical lens system. The IR-cut filter 760 can also be formed on the surfaces of the lenses and made of other materials.

The detailed optical data of the seventh embodiment is shown in table 13, and the aspheric surface data is shown in table 14.

TABLE 13
Embodiment 7
f(focal length) = 0.27 mm, Fno = 1.52, FOV = 138.6 deg.

| | | | | | | Index | Abbe # | Focal |
|---|---|---|---|---|---|---|---|---|
| surface | | Curvature Radius | | Thickness/gap | Material | (nd) | (vd) | length |
| 0 | object | infinity | | 0 | | | | |
| 1 | flat panel | infinity | | 1.479 | glass | 1.52 | 64.2 | |
| 2 | | infinity | | 0.413 | | | | |
| 3 | Lens 1 | −90.006 | (ASP) | 0.393 | plastic | 1.54 | 56 | −0.662 |
| 4 | | 0.365 | (ASP) | 0.539 | | | | |
| 5 | stop | infinity | | −0.006 | | | | |
| 6 | Lens 2 | 1.117 | (ASP) | 0.327 | plastic | 1.54 | 56 | 0.913 |
| 7 | | −0.811 | (ASP) | 0.057 | | | | |
| 8 | Lens 3 | 0.459 | (ASP) | 0.247 | plastic | 1.54 | 56 | 0.617 |
| 9 | | −1.032 | (ASP) | 0.301 | | | | |

| | | | | | | |
|---|---|---|---|---|---|---|
| 10 | IR-cut filter | infinity | 0.210 | glass | 1.52 | 64.2 |
| 11 | | infinity | 0 | | | |
| 12 | Image plane | infinity | — | | | |

Note:
reference wavelength is 537 nm

TABLE 14
Aspheric Coefficients

| surface | 3 | 4 | 6 | 7 | 8 | 9 |
|---|---|---|---|---|---|---|
| K: | 4.2549E+01 | −1.6417E−01 | −6.4296E+01 | 4.8301E+00 | −1.8840E+01 | −7.3200E+00 |
| A: | 1.1907E+00 | 3.9688E+00 | 2.0489E+00 | −1.0797E+01 | −1.4168E+00 | 4.9496E−01 |
| B: | −3.1101E−01 | 1.5705E+02 | −5.8286E−01 | 4.5241E+01 | 3.7137E+00 | 5.4059E+00 |
| C: | −4.0202E−01 | 7.0183E+02 | −1.6115E+03 | 1.2710E+02 | 8.1133E+00 | 1.9250E+01 |
| D: | −1.1857E+00 | −6.2337E+02 | −2.0599E+04 | −1.0591E+02 | −1.7847E+02 | −2.5558E+00 |
| E: | 7.0324E−01 | −8.7069E+03 | −1.7766E+05 | −2.6319E+04 | −1.8324E+03 | −5.2221E+02 |
| F: | 2.7622E+00 | −1.1766E+05 | 5.0465E+06 | −2.1297E+05 | 1.7977E+04 | −3.6497E+03 |
| G: | −2.3025E+00 | −4.0785E+06 | 3.8577E+08 | 1.2853E+06 | −2.7471E+05 | 7.5582E+03 |

In the seventh embodiment, the equation of the aspheric surface profiles of the aforementioned lenses is the same as the equation of the first embodiment. Also, the definitions of these parameters shown in the following table are the same as those stated in the first embodiment with corresponding values for the seventh embodiment, so an explanation in this regard will not be provided again.

Moreover, these parameters can be calculated from Table 13 and Table 14 as the following values and satisfy the following conditions:

Embodiment 7

| | | | |
|---|---|---|---|
| f[mm] | 0.27 | TD/OPL | 0.82 |
| Fno | 1.52 | TD/BFL | 3.05 |
| FOV[deg.] | 138.60 | TD/EPD | 8.77 |
| EPD | 0.18 | sin(HFOV)/EPD | 5.27 |
| TD/OTL | 0.39 | OTL[mm] | 3.96 |
| OTL/EPD | 22.31 | OPL[mm] | 1.89 |
| sin(HFOV)/OPL | 0.49 | BFL[mm] | 0.51 |
| sin(HFOV)/(BFL*f) | 6.79 | TD/(EPD*sin(HFOV)) | 9.37 |

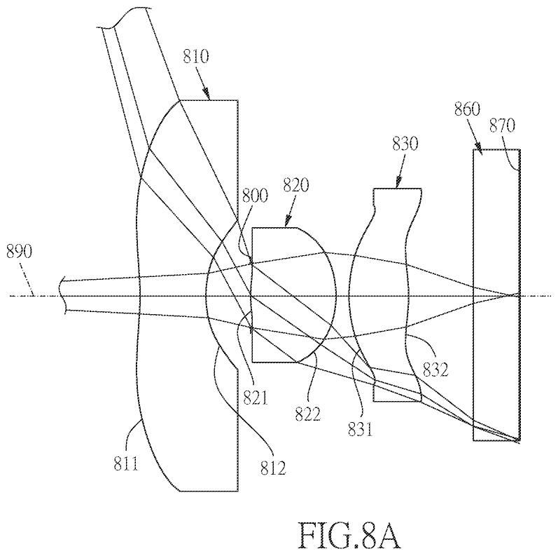

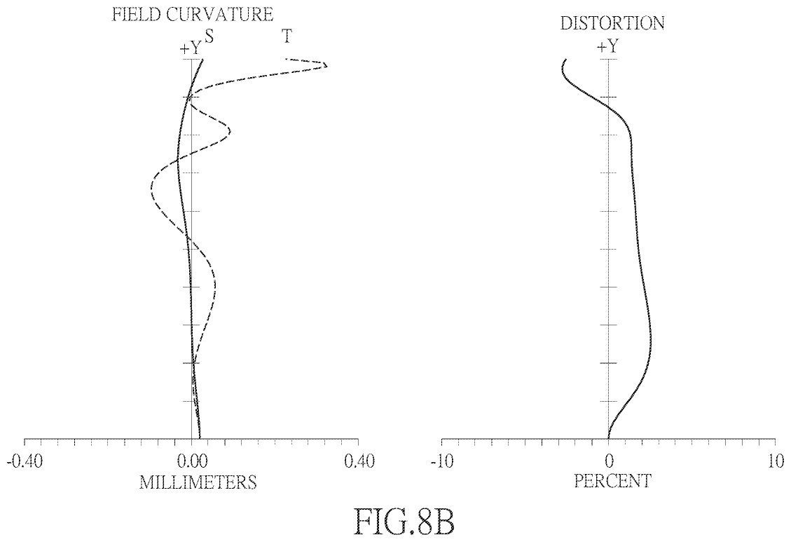

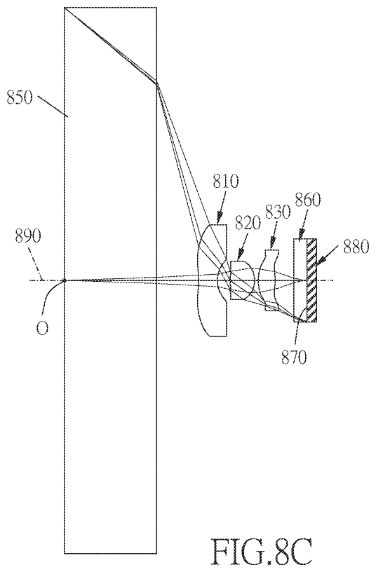

Referring to FIGS. 8A, 8B and 8C, FIG. 8A shows an optical lens system in accordance with an eighth embodiment of the present invention, FIG. 8B shows, in order from left to right, the image plane curve and the distortion curve of the eighth embodiment of the present invention, and FIG. 8C shows an imaging device in accordance with the eighth embodiment of the present invention. An optical lens system in accordance with the eighth embodiment of the present invention comprises, in order from an object side to an image side: a first lens 810, a stop 800, a second lens 820, a third lens 830, an IR-cut filter 860, and an image plane 870. The optical lens system has a total of three lenses with refractive power, but not limited to this. An imaging device in accordance with the eighth embodiment of the present invention comprises, in order from the object side to the image side: a flat panel 850, the above optical lens system (not shown), and an image sensor 880. The image sensor 880 is disposed on the image plane 870.

The flat panel 850 made of glass is located between an object O and the first lens 810 and has no influence on the focal length of the optical lens system. The flat panel 850 can be made of other materials.

The first lens 810 with negative refractive power, comprising an object-side surface 811 and an image-side surface 812, the object-side surface 811 of the first lens 810 being concave near an optical axis 890 and the image-side surface 812 of the first lens 810 being concave near the optical axis 890, the object-side surface 811 and the image-side surface 812 of the first lens 810 are aspheric, and the first lens 810 is made of plastic material.

The second lens 820 with positive refractive power, comprising an object-side surface 821 and an image-side surface 822, the object-side surface 821 of the second lens 820 being convex near the optical axis 890 and the image-side surface 822 of the second lens 820 being convex near the optical axis 890, the object-side surface 821 and the image-side surface 822 of the second lens 820 are aspheric, and the second lens 820 is made of plastic material.

The third lens 830 with positive refractive power, comprising an object-side surface 831 and an image-side surface 832, the object-side surface 831 of the third lens 830 being convex near the optical axis 890 and the image-side surface 832 of the third lens 830 being convex near the optical axis 890, the object-side surface 831 and the image-side surface 832 of the third lens 830 are aspheric, and the third lens 830 is made of plastic material.

The IR-cut filter 860 made of glass is located between the third lens 830 and the image plane 870 and has no influence on the focal length of the optical lens system. The IR-cut filter 860 can also be formed on the surfaces of the lenses and made of other materials.

The detailed optical data of the eighth embodiment is shown in table 15, and the aspheric surface data is shown in table 16.

TABLE 15
Embodiment 8
f(focal length) = 0.30 mm, Fno = 1.53, FOV = 147.5 deg.

| | | | | | | Index | Abbe # | Focal |
|---|---|---|---|---|---|---|---|---|
| surface | | Curvature Radius | | Thickness/gap | Material | (nd) | (vd) | length |
| 0 | object | infinity | | 0 | | | | |
| 1 | flat panel | infinity | | 1.479 | glass | 1.52 | 64.2 | |
| 2 | | infinity | | 0.668 | | | | |
| 3 | Lens 1 | −1.019 | (ASP) | 0.303 | plastic | 1.54 | 56 | −0.565 |
| 4 | | 0.491 | (ASP) | 0.206 | | | | |
| 5 | stop | infinity | | 0.000 | | | | |
| 6 | Lens 2 | 2.192 | (ASP) | 0.385 | plastic | 1.54 | 56 | 0.685 |
| 7 | | −0.424 | (ASP) | 0.062 | | | | |
| 8 | Lens 3 | 0.671 | (ASP) | 0.271 | plastic | 1.54 | 56 | 0.716 |
| 9 | | −0.808 | (ASP) | 0.298 | | | | |

| | | | | | | |
|---|---|---|---|---|---|---|
| 10 | IR-cut filter | infinity | 0.210 | glass | 1.52 | 64.2 |
| 11 | | infinity | 0 | | | |
| 12 | Image plane | infinity | — | | | |

Note:
reference wavelength is 537 nm

TABLE 16
Aspheric Coefficients

| surface | 3 | 4 | 6 | 7 | 8 | 9 |
|---|---|---|---|---|---|---|
| K: | −9.9998E+01 | 3.6672E−01 | −8.4939E+01 | 7.4461E−01 | 5.5789E−01 | −6.2056E−01 |
| A: | 7.8738E−01 | 4.3980E+00 | −4.9312E+00 | −1.4574E−01 | 1.1601E+00 | 5.2197E+00 |
| B: | −6.6599E−01 | −9.5106E+00 | 2.2003E+02 | −2.2349E+01 | −9.5386E−01 | 5.3584E+01 |
| C: | 3.6173E−02 | −2.5317E+02 | −3.0983E+04 | −5.1716E+01 | −4.8967E+01 | −2.5084E+02 |
| D: | 1.4236E−01 | 4.2935E+02 | −2.8418E+05 | 1.9886E+03 | 2.6553E+01 | −1.2138E+03 |
| E: | −1.7347E−02 | −1.6434E+04 | 5.2232E+07 | −1.1367E+04 | 1.6550E+03 | 2.0611E+03 |
| F: | −1.5567E−02 | −1.1271E+05 | 2.2543E+09 | −1.6912E+05 | −2.3677E+04 | 3.3963E+04 |
| G: | 4.2063E−01 | 2.2032E+06 | −1.1298E+11 | 1.9496E+06 | 1.9925E+04 | −8.9796E+04 |

In the eighth embodiment, the equation of the aspheric surface profiles of the aforementioned lenses is the same as the equation of the first embodiment. Also, the definitions of these parameters shown in the following table are the same as those stated in the first embodiment with corresponding values for the eighth embodiment, so an explanation in this regard will not be provided again.

Moreover, these parameters can be calculated from Table 15 and Table 16 as the following values and satisfy the following conditions:

Embodiment 8

| | | | |
|---|---|---|---|
| f[mm] | 0.30 | TD/OPL | 0.57 |
| Fno | 1.53 | TD/BFL | 2.41 |
| FOV[deg.] | 147.50 | TD/EPD | 6.17 |
| EPD | 0.20 | sin(HFOV)/EPD | 4.83 |
| TD/OTL | 0.32 | OTL[mm] | 3.88 |
| OTL/EPD | 19.52 | OPL[mm] | 2.15 |
| sin(HFOV)/OPL | 0.45 | BFL[mm] | 0.51 |
| sin(HFOV)/(BFL*f) | 6.21 | TD/(EPD*sin(HFOV)) | 6.43 |

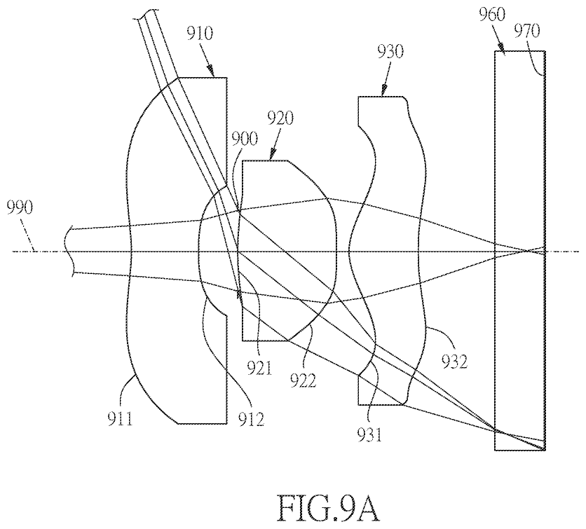

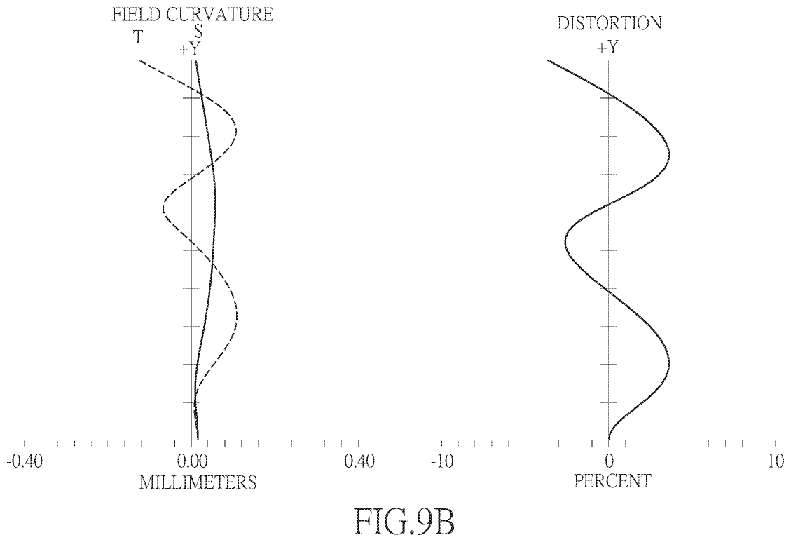

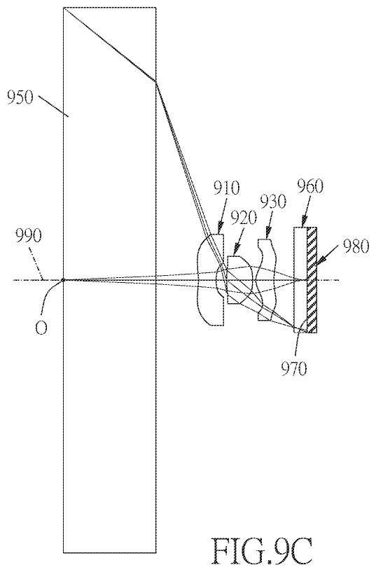

Referring to FIGS. 9A, 9B and 9C, FIG. 9A shows an optical lens system in accordance with a ninth embodiment of the present invention, FIG. 9B shows, in order from left to right, the image plane curve and the distortion curve of the ninth embodiment of the present invention, and FIG. 9C shows an imaging device in accordance with the ninth embodiment of the present invention. An optical lens system in accordance with the ninth embodiment of the present invention comprises, in order from an object side to an image side: a first lens 910, a stop 900, a second lens 920, a third lens 930, an IR-cut filter 960, and an image plane 970. The optical lens system has a total of three lenses with refractive power, but not limited to this. An imaging device in accordance with the ninth embodiment of the present invention comprises, in order from the object side to the image side: a flat panel 950, the above optical lens system (not shown), and an image sensor 980. The image sensor 980 is disposed on the image plane 970.

The flat panel 950 made of glass is located between an object O and the first lens 910 and has no influence on the focal length of the optical lens system. The flat panel 950 can be made of other materials.

The first lens 910 with negative refractive power, comprising an object-side surface 911 and an image-side surface 912, the object-side surface 911 of the first lens 910 being concave near an optical axis 990 and the image-side surface 912 of the first lens 910 being concave near the optical axis 990, the object-side surface 911 and the image-side surface 912 of the first lens 910 are aspheric, and the first lens 910 is made of plastic material.

The second lens 920 with positive refractive power, comprising an object-side surface 921 and an image-side surface 922, the object-side surface 921 of the second lens 920 being convex near the optical axis 990 and the image-side surface 922 of the second lens 920 being concave near the optical axis 990, the object-side surface 921 and the image-side surface 922 of the second lens 920 are aspheric, and the second lens 920 is made of plastic material.

The third lens 930 with positive refractive power, comprising an object-side surface 931 and an image-side surface 932, the object-side surface 931 of the third lens 930 being convex near the optical axis 990 and the image-side surface 932 of the third lens 930 being concave near the optical axis 990, the object-side surface 931 and the image-side surface 932 of the third lens 930 are aspheric, and the third lens 930 is made of plastic material.

The IR-cut filter 960 made of glass is located between the third lens 930 and the image plane 970 and has no influence on the focal length of the optical lens system. The IR-cut filter 960 can also be formed on the surfaces of the lenses and made of other materials.

The detailed optical data of the ninth embodiment is shown in table 17, and the aspheric surface data is shown in table 18.

TABLE 17
Embodiment 9
f(focal length) = 0.36 mm, Fno= 1.52, FOV = 142.1 deg.

| | | | | | | Index | Abbe # | Focal |
|---|---|---|---|---|---|---|---|---|
| surface | | Curvature Radius | | Thickness/gap | Material | (nd) | (vd) | length |
| 0 | object | infinity | | 0 | | | | |
| 1 | flat panel | infinity | | 1.479 | glass | 1.52 | 64.2 | |
| 2 | | infinity | | 0.681 | | | | |
| 3 | Lens 1 | −0.597 | (ASP) | 0.285 | plastic | 1.54 | 56 | −0.676 |
| 4 | | 1.140 | (ASP) | 0.167 | | | | |
| 5 | stop | infinity | | 0.000 | | | | |
| 6 | Lens 2 | 1.416 | (ASP) | 0.416 | plastic | 1.54 | 56 | 3.138 |
| 7 | | 7.226 | (ASP) | 0.050 | | | | |
| 8 | Lens 3 | 0.219 | (ASP) | 0.291 | plastic | 1.54 | 56 | 0.441 |
| 9 | | 1.225 | (ASP) | 0.321 | | | | |

| | | | | | | |
|---|---|---|---|---|---|---|
| 10 | IR-cut filter | infinity | 0.210 | glass | 1.52 | 64.2 |
| 11 | | infinity | 0 | | | |
| 12 | Image plane | infinity | — | | | |

Note:
reference wavelength is 537 nm

TABLE 18
Aspheric Coefficients

| surface | 3 | 4 | 6 | 7 | 8 | 9 |
|---|---|---|---|---|---|---|
| K: | −5.2070E+01 | 1.6160E+01 | 3.8716E+00 | −9.8888E+01 | −3.3685E+00 | −5.9075E+00 |
| A: | 1.4746E+00 | 1.5266E+01 | −7.3800E−01 | −2.8499E+01 | −2.3362E+00 | 2.0250E+00 |
| B: | −1.8431E+00 | −2.9602E+01 | −4.5601E+01 | 2.3694E+02 | −3.8847E−01 | −3.9008E+01 |
| C: | 2.7055E+00 | 3.1073E+02 | 2.3571E+03 | −1.2989E+03 | −3.6036E+01 | 8.3348E+01 |
| D: | −2.2472E−01 | −9.3760E+03 | −3.5184E+04 | 5.0308E+03 | −9.0623E+01 | 6.4069E+02 |
| E: | −3.5813E+00 | −2.9249E+05 | −1.3944E+06 | −3.7575E+03 | 3.2057E+03 | −4.3928E+03 |
| F: | 2.3355E+00 | 6.6409E+06 | 5.8040E+07 | −1.1192E+05 | −1.4977E+04 | 1.0540E+04 |
| G: | 2.5386E+00 | −2.6770E+07 | −5.6630E+08 | 4.5725E+05 | 2.1511E+04 | −9.1280E+03 |

In the ninth embodiment, the equation of the aspheric surface profiles of the aforementioned lenses is the same as the equation of the first embodiment. Also, the definitions of these parameters shown in the following table are the same as those stated in the first embodiment with corresponding values for the ninth embodiment, so an explanation in this regard will not be provided again.

Moreover, these parameters can be calculated from Table 17 and Table 18 as the following values and satisfy the following conditions:

Embodiment 9

| | | | |
|---|---|---|---|
| f[mm] | 0.36 | TD/OPL | 0.56 |
| Fno | 1.52 | TD/BFL | 2.28 |
| FOV[deg.] | 142.10 | TD/EPD | 5.07 |
| EPD | 0.24 | sin(HFOV)/EPD | 3.96 |
| TD/OTL | 0.31 | OTL[mm] | 3.90 |
| OTL/EPD | 16.35 | OPL[mm] | 2.16 |
| sin(HFOV)/OPL | 0.44 | BFL[mm] | 0.53 |
| sin(HFOV)/(BFL*f) | 4.91 | TD/(EPD*sin(HFOV)) | 5.36 |

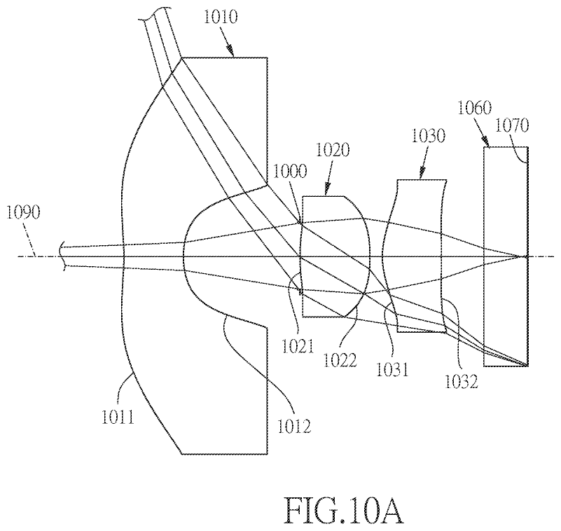

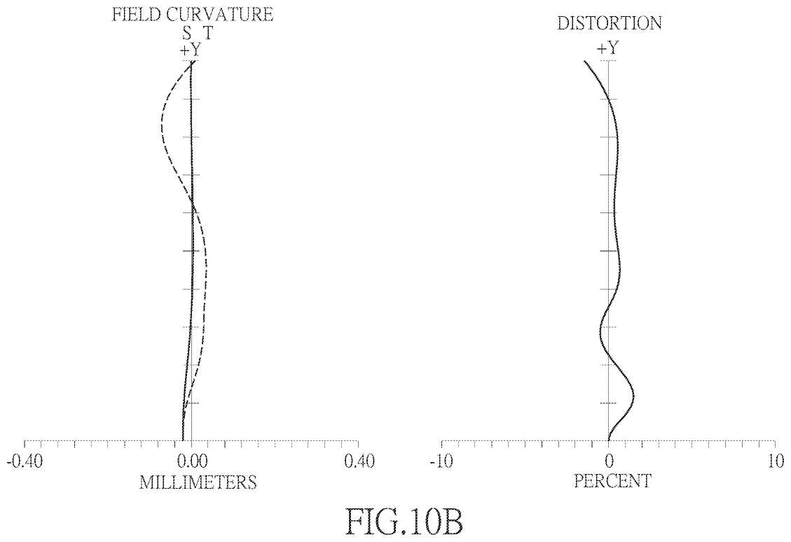

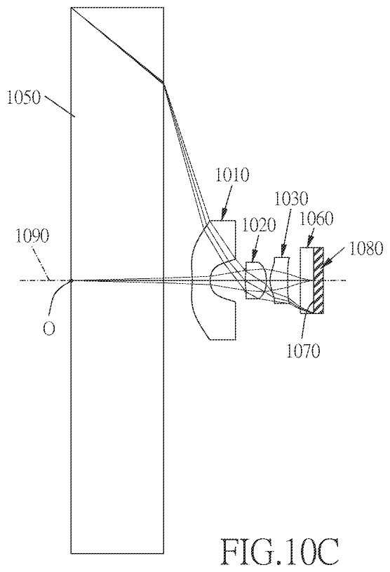

Referring to FIGS. 10A, 10B and 10C, FIG. 10A shows an optical lens system in accordance with a tenth embodiment of the present invention, FIG. 10B shows, in order from left to right, the image plane curve and the distortion curve of the tenth embodiment of the present invention, and FIG. 10C shows an imaging device in accordance with the tenth embodiment of the present invention. An optical lens system in accordance with the tenth embodiment of the present invention comprises, in order from an object side to an image side: a first lens 1010, a stop 1000, a second lens 1020, a third lens 1030, an IR-cut filter 1060, and an image plane 1070. The optical lens system has a total of three lenses with refractive power, but not limited to this. An imaging device in accordance with the tenth embodiment of the present invention comprises, in order from the object side to the image side: a flat panel 1050, the above optical lens system (not shown), and an image sensor 1080. The image sensor 1080 is disposed on the image plane 1070.

The flat panel 1050 made of glass is located between an object O and the first lens 1010 and has no influence on the focal length of the optical lens system. The flat panel 1050 can be made of other materials.

The first lens 1010 with negative refractive power, comprising an object-side surface 1011 and an image-side surface 1012, the object-side surface 1011 of the first lens 1010 being concave near an optical axis 1090 and the image-side surface 1012 of the first lens 1010 being concave near the optical axis 1090, the object-side surface 1011 and the image-side surface 1012 of the first lens 1010 are aspheric, and the first lens 1010 is made of plastic material.

The second lens 1020 with positive refractive power, comprising an object-side surface 1021 and an image-side surface 1022, the object-side surface 1021 of the second lens 1020 being convex near the optical axis 1090 and the image-side surface 1022 of the second lens 1020 being convex near the optical axis 1090, the object-side surface 1021 and the image-side surface 1022 of the second lens 1020 are aspheric, and the second lens 1020 is made of plastic material.

The third lens 1030 with positive refractive power, comprising an object-side surface 1031 and an image-side surface 1032, the object-side surface 1031 of the third lens 1030 being convex near the optical axis 1090 and the image-side surface 1032 of the third lens 1030 being convex near the optical axis 1090, the object-side surface 1031 and the image-side surface 1032 of the third lens 1030 are aspheric, and the third lens 1030 is made of plastic material.

The IR-cut filter 1060 made of glass is located between the third lens 1030 and the image plane 1070 and has no influence on the focal length of the optical lens system. The IR-cut filter 1060 can also be formed on the surfaces of the lenses and made of other materials.

The detailed optical data of the tenth embodiment is shown in table 19, and the aspheric surface data is shown in table 20.

TABLE 19
Embodiment 10
f(focal length) = 0.22 mm, Fno = 1.53, FOV = 145.7 deg.

| | | | | | | Index | Abbe # | Focal |
|---|---|---|---|---|---|---|---|---|
| surface | | Curvature Radius | | Thickness/gap | Material | (nd) | (vd) | length |
| 0 | object | infinity | | 0 | | | | |
| 1 | flat panel | infinity | | 1.479 | glass | 1.52 | 64.2 | |
| 2 | | infinity | | 0.456 | | | | |
| 3 | Lens 1 | −1.069 | (ASP) | 0.290 | plastic | 1.54 | 56 | −0.517 |
| 4 | | 0.422 | (ASP) | 0.557 | | | | |
| 5 | stop | infinity | | 0.000 | | | | |
| 6 | Lens 2 | 0.794 | (ASP) | 0.338 | plastic | 1.54 | 56 | 0.896 |
| 7 | | −1.089 | (ASP) | 0.058 | | | | |
| 8 | Lens 3 | 0.316 | (ASP) | 0.285 | plastic | 1.54 | 56 | 0.567 |
| 9 | | −11.398 | (ASP) | 0.208 | | | | |

| | | | | | | |
|---|---|---|---|---|---|---|
| 10 | IR-cut filter | infinity | 0.210 | glass | 1.52 | 64.2 |
| 11 | | infinity | 0 | | | |
| 12 | Image plane | infinity | — | | | |

Note:
reference wavelength is 537 nm

TABLE 20
Aspheric Coefficients

| surface | 3 | 4 | 6 | 7 | 8 | 9 |
|---|---|---|---|---|---|---|
| K: | −1.0002E+02 | 4.8485E−01 | 1.6772E+01 | 1.0275E+01 | −7.7000E+00 | −9.9636E+01 |
| A: | 1.5825E+00 | 1.2969E+01 | −9.0634E+00 | −1.9850E+01 | 9.2975E−01 | 6.5698E−01 |
| B: | −2.2035E+00 | 2.4019E+00 | −2.6065E+00 | 2.1788E+02 | −2.9898E+01 | 1.8128E+01 |
| C: | 6.2487E−01 | 2.8453E+02 | −6.2575E+03 | −1.0262E+03 | 1.8188E+02 | −1.0845E+02 |
| D: | 1.4232E+00 | 6.7329E+03 | −1.1368E+05 | −4.1178E+03 | 9.8392E+02 | 4.8732E+02 |
| E: | −7.0207E−01 | 4.3784E+04 | 4.8245E+06 | −8.1991E+03 | −1.0977E+04 | 3.2925E+02 |
| F: | −8.8113E−01 | −5.0271E+05 | 1.8241E+08 | 1.2991E+05 | −1.2701E+05 | −1.0218E+04 |
| G: | 5.5537E−01 | −4.9152E+06 | −7.6898E+09 | 9.1443E+05 | 5.8294E+05 | −1.0941E+04 |

In the tenth embodiment, the equation of the aspheric surface profiles of the aforementioned lenses is the same as the equation of the first embodiment. Also, the definitions of these parameters shown in the following table are the same as those stated in the first embodiment with corresponding values for the tenth embodiment, so an explanation in this regard will not be provided again.

Moreover, these parameters can be calculated from Table 19 and Table 20 as the following values and satisfy the following conditions:

Embodiment 10

| | | | |
|---|---|---|---|
| f[mm] | 0.22 | TD/OPL | 0.79 |
| Fno | 1.53 | TD/BFL | 3.66 |
| FOV[deg.] | 145.70 | TD/EPD | 10.81 |
| EPD | 0.14 | sin(HFOV)/EPD | 6.76 |
| TD/OTL | 0.39 | OTL[mm] | 3.88 |
| OTL/EPD | 27.47 | OPL[mm] | 1.93 |
| sin(HFOV)/OPL | 0.49 | BFL[mm] | 0.42 |
| sin(HFOV)/(BFL*f) | 10.58 | TD/(EPD*sin(HFOV)) | 11.32 |

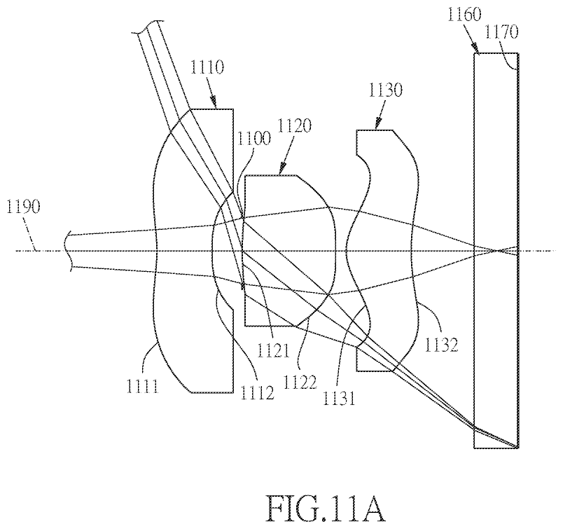

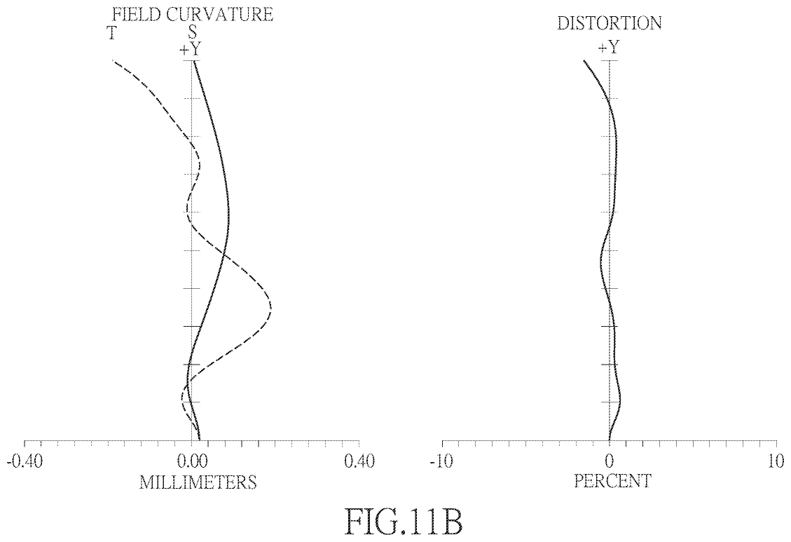

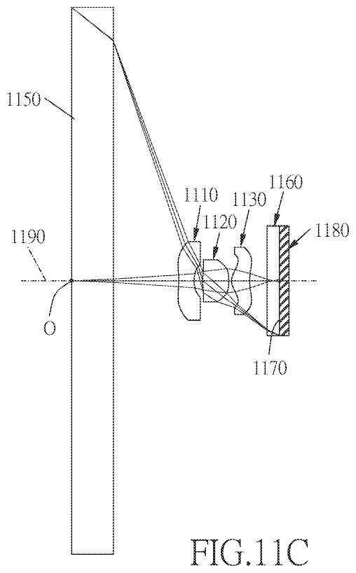

Referring to FIGS. 11A, 11B and 11C, FIG. 11A shows an optical lens system in accordance with an eleventh embodiment of the present invention, FIG. 11B shows, in order from left to right, the image plane curve and the distortion curve of the eleventh embodiment of the present invention, and FIG. 11C shows an imaging device in accordance with the eleventh embodiment of the present invention. An optical lens system in accordance with the eleventh embodiment of the present invention comprises, in order from an object side to an image side: a first lens 1110, a stop 1100, a second lens 1120, a third lens 1130, an IR-cut filter 1160, and an image plane 1170. The optical lens system has a total of three lenses with refractive power, but not limited to this. An imaging device in accordance with the eleventh embodiment of the present invention comprises, in order from the object side to the image side: a flat panel 1150, the above optical lens system (not shown), and an image sensor 1180. The image sensor 1180 is disposed on the image plane 1170.

The flat panel 1150 made of glass is located between an object O and the first lens 1110 and has no influence on the focal length of the optical lens system. The flat panel 1150 can be made of other materials.

The first lens 1110 with negative refractive power, comprising an object-side surface 1111 and an image-side surface 1112, the object-side surface 1111 of the first lens 1110 being concave near an optical axis 1190 and the image-side surface 1112 of the first lens 1110 being convex near the optical axis 1190, the object-side surface 1111 and the image-side surface 1112 of the first lens 1110 are aspheric, and the first lens 1110 is made of plastic material.

The second lens 1120 with positive refractive power, comprising an object-side surface 1121 and an image-side surface 1122, the object-side surface 1121 of the second lens 1120 being convex near the optical axis 1190 and the image-side surface 1122 of the second lens 1120 being concave near the optical axis 1190, the object-side surface 1121 and the image-side surface 1122 of the second lens 1120 are aspheric, and the second lens 1120 is made of plastic material.

The third lens 1130 with positive refractive power, comprising an object-side surface 1131 and an image-side surface 1132, the object-side surface 1131 of the third lens 1130 being convex near the optical axis 1190 and the image-side surface 1132 of the third lens 1130 being concave near the optical axis 1190, the object-side surface 1131 and the image-side surface 1132 of the third lens 1130 are aspheric, and the third lens 1130 is made of plastic material.

The IR-cut filter 1160 made of glass is located between the third lens 1130 and the image plane 1170 and has no influence on the focal length of the optical lens system. The IR-cut filter 1160 can also be formed on the surfaces of the lenses and made of other materials.

The detailed optical data of the eleventh embodiment is shown in table 21, and the aspheric surface data is shown in table 22.

TABLE 21
Embodiment 11
f(focal length) = 0.37 mm, Fno = 1.52, FOV = 140.7 deg.

| | | | | | | Index | Abbe # | Focal |
|---|---|---|---|---|---|---|---|---|
| surface | | Curvature Radius | | Thickness/gap | Material | (nd) | (vd) | length |
| 0 | object | infinity | | 0 | | | | |
| 1 | flat panel | infinity | | 0.737 | glass | 1.52 | 64.2 | |
| 2 | | infinity | | 1.171 | | | | |
| 3 | Lens 1 | −0.601 | (ASP) | 0.271 | plastic | 1.54 | 56 | −0.683 |
| 4 | | 1.146 | (ASP) | 0.150 | | | | |
| 5 | stop | infinity | | 0.000 | | | | |
| 6 | Lens 2 | 1.459 | (ASP) | 0.461 | plastic | 1.54 | 56 | 3.433 |
| 7 | | 5.802 | (ASP) | 0.052 | | | | |
| 8 | Lens 3 | 0.221 | (ASP) | 0.317 | plastic | 1.54 | 56 | 0.440 |
| 9 | | 1.284 | (ASP) | 0.315 | | | | |

| | | | | | | |
|---|---|---|---|---|---|---|
| 10 | IR-cut filter | infinity | 0.210 | glass | 1.52 | 64.2 |
| 11 | | infinity | 0 | | | |
| 12 | Image plane | infinity | — | | | |

Note:
reference wavelength is 537 nm

TABLE 22
Aspheric Coefficients

| surface | 3 | 4 | 6 | 7 | 8 | 9 |
|---|---|---|---|---|---|---|
| K: | −5.8581E+01 | 8.5296E+00 | 5.9548E+00 | 1.0026E+02 | −2.8151E+00 | 8.1863E−01 |
| A: | 1.7932E+00 | 1.4377E+01 | −6.4980E−01 | −2.7119E+01 | −2.7267E+00 | 2.1606E+00 |
| B: | −2.5250E+00 | −6.6543E+01 | −4.5403E+01 | 2.2901E+02 | −1.5639E+00 | −3.9386E+01 |
| C: | 2.1301E+00 | 1.2787E+02 | 2.3983E+03 | −1.3417E+03 | −3.9553E+01 | 8.0025E+01 |
| D: | −5.0800E−02 | −6.9536E+03 | −3.4802E+04 | 5.0696E+03 | −1.0431E+02 | 6.3016E+02 |
| E: | −2.4688E+00 | −2.4783E+05 | −1.3768E+06 | −2.6894E+03 | 3.1781E+03 | −4.4182E+03 |
| F: | 4.0570E+00 | 6.7159E+06 | 5.8040E+07 | −1.0829E+05 | −1.5069E+04 | 1.0533E+04 |
| G: | 1.9085E+00 | −3.5352E+07 | −5.8043E+08 | 4.3478E+05 | 1.9595E+04 | −8.8078E+03 |

In the eleventh embodiment, the equation of the aspheric surface profiles of the aforementioned lenses is the same as the equation of the first embodiment. Also, the definitions of these parameters shown in the following table are the same as those stated in the first embodiment with corresponding values for the eleventh embodiment, so an explanation in this regard will not be provided again.

Moreover, these parameters can be calculated from Table 21 and Table 22 as the following values and satisfy the following conditions:

Embodiment 11

| | | | |
|---|---|---|---|
| f[mm] | 0.37 | TD/OPL | 0.66 |
| Fno | 1.52 | TD/BFL | 2.38 |
| FOV[deg.] | 140.70 | TD/EPD | 5.14 |
| EPD | 0.24 | sin(HFOV)/EPD | 3.87 |
| TD/OTL | 0.34 | OTL[mm] | 3.68 |
| OTL/EPD | 15.14 | OPL[mm] | 1.91 |
| sin(HFOV)/OPL | 0.49 | BFL[mm] | 0.53 |
| sin(HFOV)/(BFL*f) | 4.85 | TD/(EPD*sin(HFOV)) | 5.46 |

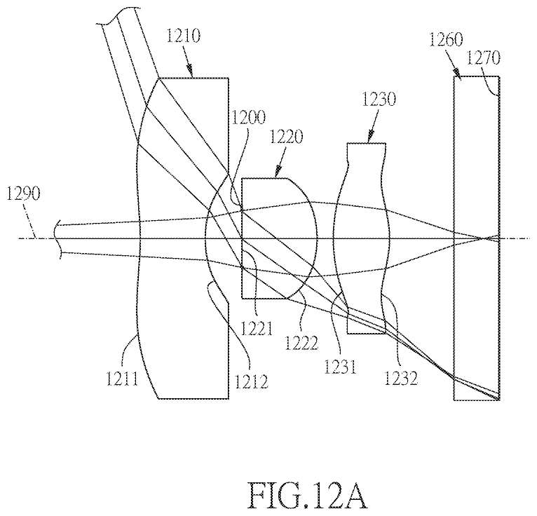

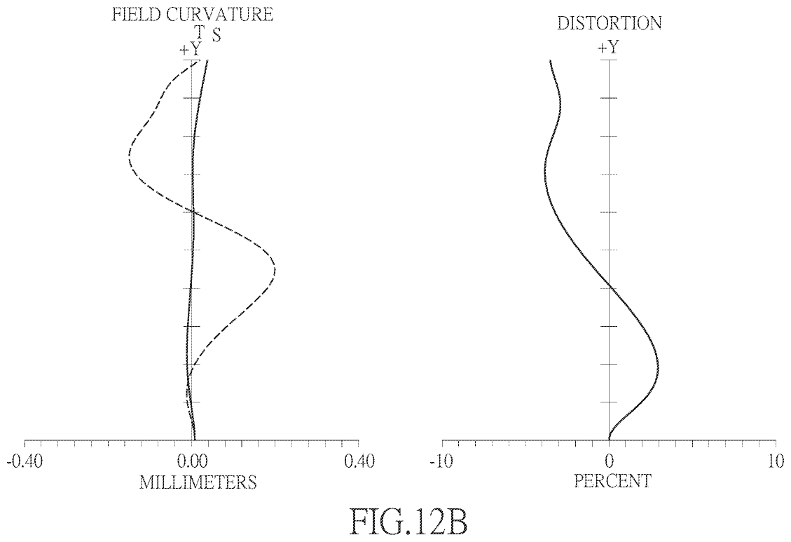

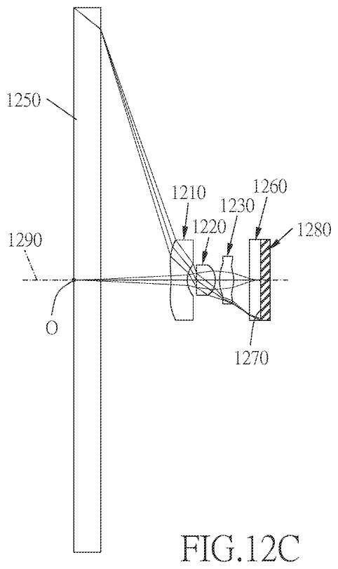

Referring to FIGS. 12A, 12B and 12C, FIG. 12A shows an optical lens system in accordance with a twelfth embodiment of the present invention, FIG. 12B shows, in order from left to right, the image plane curve and the distortion curve of the twelfth embodiment of the present invention, and FIG. 12C shows an imaging device in accordance with the twelfth embodiment of the present invention. An optical lens system in accordance with the twelfth embodiment of the present invention comprises, in order from an object side to an image side: a first lens 1210, a stop 1200, a second lens 1220, a third lens 1230, an IR-cut filter 1260, and an image plane 1270. The optical lens system has a total of three lenses with refractive power, but not limited to this. An imaging device in accordance with the twelfth embodiment of the present invention comprises, in order from the object side to the image side: a flat panel 1250, the above optical lens system (not shown), and an image sensor 1280. The image sensor 1280 is disposed on the image plane 1270.

The flat panel 1250 made of glass is located between an object O and the first lens 1210 and has no influence on the focal length of the optical lens system. The flat panel 1250 can be made of other materials.

The first lens 1210 with negative refractive power, comprising an object-side surface 1211 and an image-side surface 1212, the object-side surface 1211 of the first lens 1210 being concave near an optical axis 1290 and the image-side surface 1212 of the first lens 1210 being concave near the optical axis 1290, the object-side surface 1211 and the image-side surface 1212 of the first lens 1210 are aspheric, and the first lens 1210 is made of plastic material.

The second lens 1220 with positive refractive power, comprising an object-side surface 1221 and an image-side surface 1222, the object-side surface 1221 of the second lens 1220 being convex near the optical axis 1290 and the image-side surface 1222 of the second lens 1220 being convex near the optical axis 1290, the object-side surface 1221 and the image-side surface 1222 of the second lens 1220 are aspheric, and the second lens 1220 is made of plastic material.

The third lens 1230 with positive refractive power, comprising an object-side surface 1231 and an image-side surface 1232, the object-side surface 1231 of the third lens 1230 being convex near the optical axis 1290 and the image-side surface 1232 of the third lens 1230 being convex near the optical axis 1290, the object-side surface 1231 and the image-side surface 1232 of the third lens 1230 are aspheric, and the third lens 1230 is made of plastic material.

The IR-cut filter 1260 made of glass is located between the third lens 1230 and the image plane 1270 and has no influence on the focal length of the optical lens system. The IR-cut filter 1260 can also be formed on the surfaces of the lenses and made of other materials.

The detailed optical data of the twelfth embodiment is shown in table 23, and the aspheric surface data is shown in table 24.

TABLE 23
Embodiment 12
f(focal length) = 0.29 mm, Fno = 1.53, FOV = 143.0 deg.

| | | | | | | Index | Abbe # | Focal |
|---|---|---|---|---|---|---|---|---|
| surface | | Curvature Radius | | Thickness/gap | Material | (nd) | (vd) | length |
| 0 | object | infinity | | 0 | | | | |
| 1 | flat panel | infinity | | 0.500 | glass | 1.52 | 64.2 | |
| 2 | | infinity | | 1.308 | | | | |
| 3 | Lens 1 | −0.840 | (ASP) | 0.302 | plastic | 1.54 | 56 | −0.545 |
| 4 | | 0.522 | (ASP) | 0.168 | | | | |
| 5 | stop | infinity | | 0.000 | | | | |
| 6 | Lens 2 | 2.118 | (ASP) | 0.350 | plastic | 1.54 | 56 | 0.692 |
| 7 | | −0.435 | (ASP) | 0.078 | | | | |
| 8 | Lens 3 | 0.798 | (ASP) | 0.259 | plastic | 1.54 | 56 | 0.596 |
| 9 | | −0.489 | (ASP) | 0.295 | | | | |

| | | | | | | |
|---|---|---|---|---|---|---|
| 10 | IR-cut filter | infinity | 0.210 | glass | 1.52 | 64.2 |
| 11 | | infinity | 0 | | | |
| 12 | Image plane | infinity | — | | | |

Note:
reference wavelength is 537 nm

TABLE 24
Aspheric Coefficients

| surface | 3 | 4 | 6 | 7 | 8 | 9 |
|---|---|---|---|---|---|---|
| K: | −9.5252E+01 | 3.3589E−01 | −1.0213E+02 | 1.0619E+00 | −3.6521E−01 | −4.2808E−01 |
| A: | 8.3943E−01 | 4.3533E+00 | −6.1446E+00 | 2.7630E−01 | 8.5158E−01 | 5.1888E+00 |
| B: | −6.7387E−01 | −7.6858E+00 | 4.0833E+02 | −4.6562E+01 | −6.1254E+00 | 5.6299E+01 |
| C: | 5.7549E−02 | −2.8250E+02 | −2.6131E+04 | −1.5422E+02 | −4.1235E+01 | −2.4157E+02 |
| D: | 1.8836E−01 | 2.0138E+02 | −4.3362E+05 | 2.8216E+03 | 2.1199E+02 | −1.1980E+03 |
| E: | 3.6616E−03 | −1.6848E+04 | 3.9728E+07 | 3.7098E+03 | 2.7131E+03 | 2.0434E+03 |
| F: | −1.1960E−01 | −1.2279E+05 | 1.8828E+09 | −6.9448E+04 | −3.1122E+04 | 3.3718E+04 |
| G: | 1.1864E−01 | 2.1607E+06 | −9.4222E+10 | 1.5511E+06 | −1.5355E+05 | −9.0414E+04 |

In the twelfth embodiment, the equation of the aspheric surface profiles of the aforementioned lenses is the same as the equation of the first embodiment. Also, the definitions of these parameters shown in the following table are the same as those stated in the first embodiment with corresponding values for the twelfth embodiment, so an explanation in this regard will not be provided again.

Moreover, these parameters can be calculated from Table 23 and Table 24 as the following values and satisfy the following conditions:

Embodiment 12

| | | | |
|---|---|---|---|
| f[mm] | 0.29 | TD/OPL | 0.64 |
| Fno | 1.53 | TD/BFL | 2.29 |
| FOV[deg.] | 143.00 | TD/EPD | 6.16 |
| EPD | 0.19 | sin(HFOV)/EPD | 5.05 |
| TD/OTL | 0.33 | OTL[mm] | 3.47 |
| OTL/EPD | 18.48 | OPL[mm] | 1.81 |
| sin(HFOV)/OPL | 0.52 | BFL[mm] | 0.51 |
| sin(HFOV)/(BFL*f) | 6.54 | TD/(EPD*sin(HFOV)) | 6.50 |

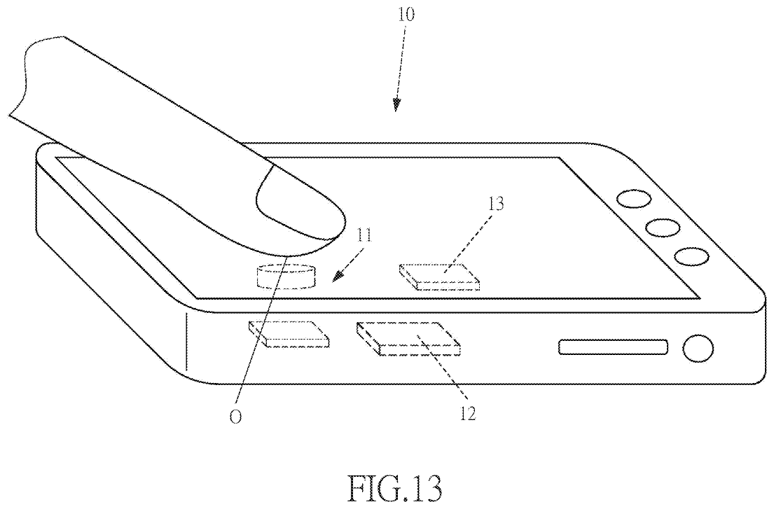

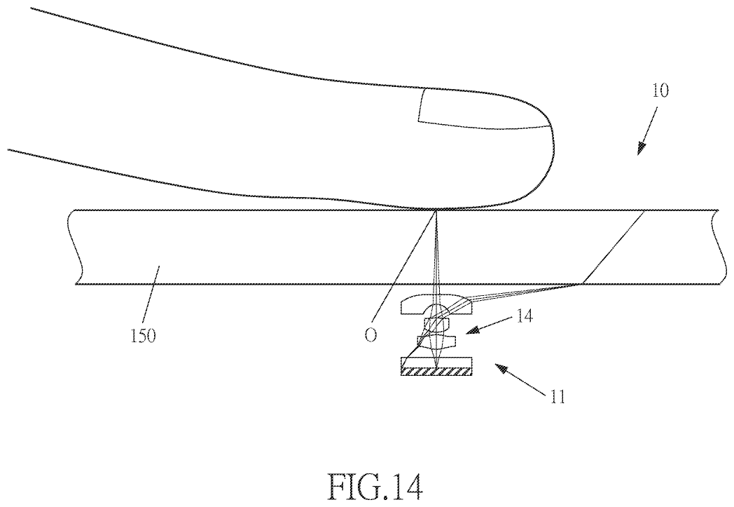

Referring to FIGS. 13 and 14, FIG. 13 shows an imaging device 11 that includes an optical lens system 14 is disposed on an electronic device 10 in accordance with the first embodiment of the present invention, but not limited to this. The imaging devices of each of the above embodiments can be disposed on the electronic device 10, which makes the electronic device 10 has a fingerprint biometric identification (biometric) system. FIG. 14 is a cross sectional side view of FIG. 13. The electronic device 10 comprises the imaging device 11, a control unit 12 electrically connected to the imaging device 11, and a storage unit 13 electrically connected to the control unit 12. Preferably, the electronic device 10 may further include a display unit (display units), a temporary storage unit (RAM), a battery, a communication module, a touch module, a housing, or a combination thereof.

The present invention can also be used in electronic devices, such as, digital camera, mobile device, digital flat panel, Smart TV and wearable device.

While we have shown and described various embodiments in accordance with the present invention, it should be clear to those skilled in the art that further embodiments may be made without departing from the scope of the present invention.

What is claimed is:

1. An optical lens system, in order from an object side to an image side, comprising:
a first lens with negative refractive power, comprising an object-side surface and an image-side surface, the object-side surface of the first lens being concave near an optical axis, and at least one of the object-side surface and the image-side surface of the first lens being aspheric;
a stop;
a second lens with positive refractive power, comprising an object-side surface and an image-side surface, and at least one of the object-side surface and the image-side surface of the second lens being aspheric;
a third lens with positive refractive power, comprising an object-side surface and an image-side surface, and at least one of the object-side surface and the image-side surface of the third lens being aspheric;
wherein a distance from the object-side surface of the first lens to the image-side surface of the third lens along the optical axis is TD, a distance from the image-side surface of the third lens to an image plane along the optical axis is BFL, half of a maximum view angle (field of view) of the optical lens system is HFOV, an incident pupil aperture of the optical lens system is EPD, and following conditions are satisfied: 1.82<TD/BFL<3.8 and 3.10<sin(HFOV)/EPD<8.12.

2. The optical lens system as claimed in claim 1, wherein the distance from the object-side surface of the first lens to the image-side surface of the third lens along the optical axis is TD, the incident pupil aperture of the optical lens system is EPD, and following condition is satisfied: 4.06<TD/EPD<12.97.

3. The optical lens system as claimed in claim 1, wherein the distance from the image-side surface of the third lens to the image plane along the optical axis is BFL, and following condition is satisfied: 0.36 mm<BFL<0.58 mm.

4. The optical lens system as claimed in claim 1, wherein the distance from the object-side surface of the first lens to the image-side surface of the third lens along the optical axis is TD, the distance from the image-side surface of the third lens to the image plane along the optical axis is BFL, and following condition is satisfied: 2.05<TD/BFL<3.7.

5. The optical lens system as claimed in claim 1, wherein the incident pupil aperture of the optical lens system is EPD, and following condition is satisfied: 0.11<EPD<0.29.

6. The optical lens system as claimed in claim 1, wherein half of the maximum view angle (field of view) of the optical lens system is HFOV, the incident pupil aperture of the optical lens system is EPD, and following condition is satisfied: 3.48<sin(HFOV)/EPD<7.44.

7. The optical lens system as claimed in claim 1, wherein half of the maximum view angle (field of view) of the optical lens system is HFOV, the distance from the image-side surface of the third lens to the image plane along the optical axis is BFL, a focal length of the optical lens system is f, and following condition is satisfied: 4.36<sin(HFOV)/(BFL*f)<11.64.

8. The optical lens system as claimed in claim 1, wherein half of the maximum view angle (field of view) of the optical lens system is HFOV, the distance from the object-side surface of the first lens to the image-side surface of the third lens along the optical axis is TD, the incident pupil aperture of the optical lens system is EPD, and following condition is satisfied: 4.83<TD/(EPD*sin(HFOV))<12.45.

9. An imaging device, in order from an object side to an image side, comprising:
a flat panel;
an optical lens system; and
an image sensor;
wherein the optical lens system, in order from the object side to the image side, comprising:
a first lens with negative refractive power, comprising an object-side surface and an image-side surface, the object-side surface of the first lens being concave near an optical axis, and at least one of the object-side surface and the image-side surface of the first lens being aspheric;
a stop;
a second lens with positive refractive power, comprising an object-side surface and an image-side surface, and at least one of the object-side surface and the image-side surface of the second lens being aspheric;
a third lens with positive refractive power, comprising an object-side surface and an image-side surface, and at least one of the object-side surface and the image-side surface of the third lens being aspheric;
wherein half of a maximum view angle (field of view) of the optical lens system is HFOV, a distance from an object-side surface of the flat panel to the object-side surface of the first lens along the optical axis is OPL, a distance from the object-side surface of the first lens to the image-side surface of the third lens along the optical axis is TD, a distance from the object-side surface of the flat panel to an image plane along the optical axis is OTL, and following conditions are satisfied: 0.34<sin(HFOV)/OPL<0.71 and 0.25<TD/OTL<0.44.

10. The imaging device as claimed in claim 9, wherein the distance from the object-side surface of the flat panel to the image plane along the optical axis is OTL, an incident pupil aperture of the optical lens system is EPD, and following condition is satisfied: 12.11<OTL/EPD<30.

11. The imaging device as claimed in claim 9, wherein the distance from the object-side surface of the first lens to the image-side surface of the third lens along the optical axis is TD, the distance from the object-side surface of the flat panel to the object-side surface of the first lens along the optical axis is OPL, and following condition is satisfied: 0.42<TD/OPL<1.04.

12. The imaging device as claimed in claim 9, wherein the distance from the object-side surface of the first lens to the image-side surface of the third lens along the optical axis is TD, a distance from the image-side surface of the third lens to the image plane along the optical axis is BFL, and following condition is satisfied: 1.82<TD/BFL<3.8.

13. The imaging device as claimed in claim 9, wherein the distance from the object-side surface of the first lens to the image-side surface of the third lens along the optical axis is TD, an incident pupil aperture of the optical lens system is EPD, and following condition is satisfied: 4.06<TD/EPD<12.97.

14. The imaging device as claimed in claim 9, wherein the distance from the object-side surface of the flat panel to the image plane along the optical axis is OTL, and following condition is satisfied: 2.84 mm<OTL<4.35 mm.

15. The imaging device as claimed in claim 9, wherein the distance from the object-side surface of the flat panel to the object-side surface of the first lens along the optical axis is OPL, and following condition is satisfied: 1.35 mm<OPL<2.66 mm.

16. The imaging device as claimed in claim 9, wherein the distance from the object-side surface of the first lens to the image-side surface of the third lens along the optical axis is TD, a distance from the image-side surface of the third lens to the image plane along the optical axis is BFL, half of the maximum view angle (field of view) of the optical lens system is HFOV, an incident pupil aperture of the optical lens system is EPD, and following conditions are satisfied: 1.82<TD/BFL<3.8 and 3.10<sin(HFOV)/EPD<8.12.

17. The imaging device as claimed in claim 9, wherein an incident pupil aperture of the optical lens system is EPD, and following condition is satisfied: 0.11<EPD<0.29.

18. The imaging device as claimed in claim 9, wherein half of the maximum view angle (field of view) of the optical lens system is HFOV, a distance from the image-side surface of the third lens to the image plane along the optical axis is BFL, a focal length of the optical lens system is f, and following condition is satisfied: 4.36<sin(HFOV)/(BFL*f)<11.64.

19. The imaging device as claimed in claim 9, wherein half of the maximum view angle (field of view) of the optical lens system is HFOV, the distance from the object-side surface of the first lens to the image-side surface of the third lens along the optical axis is TD, an incident pupil aperture of the optical lens system is EPD, and following condition is satisfied: 4.83<TD/(EPD*sin(HFOV))<12.45.

20. An electronic device, comprising: the imaging device as claimed in claim 9, a control unit being electrically connected to the imaging device, and a storage unit being electrically connected to the control unit.
